(19) United States
(12) Patent Application Publication
(10) Pub. No.: US 2026/0368356 A1
(43) Pub. Date: Nov. 19, 2026

(54) SYSTEM AND METHOD FOR EXCLUDING CONTENT FROM RESOURCE SEARCH REQUESTS BASED ON CONTENT BASED ACCESS PERMISSIONS FOR CLOUD BACKUPS

(71) Applicant: EON IO Ltd., Tel Aviv (IL)

(72) Inventors: Ron Kimchi, Tel Aviv (IL); Dor Tchizik, Tel Aviv (IL); Assaf Natanzon, Tel Aviv (IL); Shani Sharabani, Ramat Gan (IL)

(73) Assignee: EON IO Ltd., Tel Aviv (IL)

(21) Appl. No.: 19/206,820

(22) Filed: May 13, 2025

(51) Int. Cl. G06F 21/62; H04L 9/40

(52) U.S. Cl. CPC G06F 21/6245; H04L 63/105

(57) ABSTRACT

In one embodiment, a method comprises responsive to a search request from a computing system of a user of an organization, identifying a resource that is backed up in a cloud backup environment; identifying a role of the user from a plurality of roles established for the organization, wherein the role is assignable to a plurality of users of the organization; selecting a portion of the resource to exclude from a representation of the resource, wherein the selection of the portion is based on the role of the user; and initiating communication of the representation of the resource to the computing system of the user.

### TECHNICAL FIELD

This disclosure relates in general to the field of computing applications and, more particularly, to a system and method for roles with content based access permissions for cloud backups.

### BACKGROUND

Cloud backup is the process of creating and storing copies data in a remote, cloud-based environment to ensure data availability, protection, and recovery in case of failure or data loss. While organizations may utilize traditional on-premises backups, cloud backups offer greater flexibility and scalability, allowing businesses to adjust storage as needed and access their data from anywhere with an internet connection. Cloud backups typically provide automated processes, encryption, and redundancy across multiple servers, enhancing both security and reliability. This ensures that businesses can recover their data quickly, minimizing downtime and mitigating the risk of data breaches or corruption.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a block diagram of a cloud backup environment, in accordance with any of the embodiments disclosed herein.

FIG. 2 illustrates a block diagram of a backend of a cloud backup service provider of the environment of FIG. 1, in accordance with any of the embodiments disclosed herein.

FIG. 3 illustrates a block diagram of a computing device of FIG. 1, in accordance with any of the embodiments disclosed herein.

FIG. 4 illustrates an example database metadata record, in accordance with any of the embodiments disclosed herein.

FIG. 5 illustrates a database preview record, in accordance with any of the embodiments disclosed herein.

FIG. 6 illustrates an enhanced database search interface, in accordance with any of the embodiments disclosed herein.

FIG. 7 illustrates a database preview, in accordance with any of the embodiments disclosed herein.

FIG. 8 illustrates a database explorer for submitting queries to partitioned database backups, in accordance with any of the embodiments disclosed herein.

FIG. 9 illustrates a partitioned database backup, in accordance with any of the embodiments disclosed herein.

FIG. 10 illustrates an interface for managing roles with content based access permissions for data backups, in accordance with any of the embodiments disclosed herein.

FIG. 11 illustrates an interface for managing a plurality of content based access permissions for data backups, in accordance with any of the embodiments disclosed herein.

FIG. 12 illustrates the interface of FIG. 11 during configuration of a permission, in accordance with any of the embodiments disclosed herein.

FIG. 13 illustrates an interface for configuring a content based access permission, in accordance with any of the embodiments disclosed herein.

FIG. 14 illustrates another view of the interface for configuring a content based access permission, in accordance with any of the embodiments disclosed herein.

FIG. 15 illustrates an interface providing search results of backed up files, in accordance with any of the embodiments disclosed herein.

FIG. 16 illustrates an inventory of data backups, in accordance with any of the embodiments disclosed herein.

FIG. 17 illustrates a flow for setting up a system to implement roles with content based access permissions, in accordance with any of the embodiments disclosed herein.

FIG. 18 illustrates a flow for servicing requests for resources using roles with content based access permissions, in accordance with any of the embodiments disclosed herein.

FIG. 19 illustrates a flow for excluding portions of resources based on roles with content based access permissions, in accordance with any of the embodiments disclosed herein.

### DETAILED DESCRIPTION OF EXAMPLE EMBODIMENTS

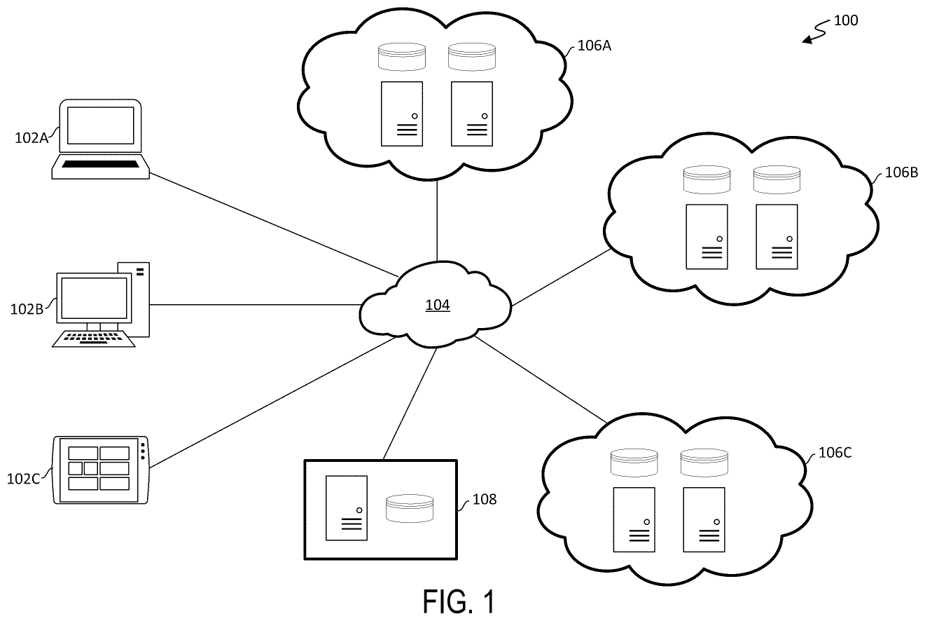

FIG. 1 illustrates a block diagram of a cloud backup environment 100, in accordance with any of the embodiments disclosed herein. An organization (e.g., any one or more users associated with each other) may be associated with any number of data structures (e.g., databases, virtual machines, files, buckets or other groupings of files) that are accessed by users associated with the organization. As used herein, “resource” may refer to one or more of a data structure that is not backed up, a data structure that is backed up, a backup of a data structure, or a backup of multiple versions of a data structure. The users may interact with the resources using computing devices 102 (e.g., 102A, 102B, 102C).

The resources may be stored (temporarily or persistently) at a site owned or leased by the organization (e.g., “on premises”), at another location (e.g., owned or managed by a cloud service provider), or at multiple locations. The resources of an organization may be backed up in the cloud, e.g., within a backend 106 (e.g., 106A, 106B, 106C) of a cloud backup service provider, across multiple backends of the same cloud backup service provider, at one or more backends of a different cloud backup service provider, at another suitable location (e.g., at a local site of the organization), or any combination thereof (e.g., some resources may be backed up at backend 106A, other resources may be backed up at backend 106B, and some resources may be backed up at a local site). In some instances, the organization may also have resources that are not backed up (but rather stored locally, in the cloud, or otherwise).

An organization may include any number of users that utilize computing devices 102 to perform operations with respect to resources associated with the organization. The interaction between a user and a resource may be indirect and facilitated by a frontend interface, such as a web browser, a desktop application, a mobile application, or other interface. In some embodiments, with respect to resources that are databases, the interface may translate requests of the user into a format (e.g., a database query language, such as Structured Query Language (SQL)) that is compatible with a database management system (DBMS) which processes the requests and returns requested data and/or confirmation of completion of requests. The interface may then present the requested data or confirmation in a format that is user friendly. In some instances, a user may interface with a database in a more direct manner, e.g., through a database client tool that allows the user to write and execute database queries directly.

Large organizations tend to have significant amounts of databases and other resources. For example, a large enterprise may have hundreds, thousands, or even tens of thousands of databases (or at least tens of thousands of database tables within hundreds or thousands of different databases). In such environments, finding the correct database (or more particularly the correct table of a database) in order to restore data (e.g., a full database, a specific table, etc.), initiate a backup, or query data may be very tedious. Even with robust search functionality, finding a database may be difficult without viewing the actual contents of the database. However, mounting and configuring a database in order to access its contents may be a time consuming endeavor (e.g., on the order of minutes per database), even in modern backup solutions. The process may take even longer if the wrong database or wrong database version is selected. Similar issues may be encountered with respect to other resources that may be backed up (e.g., virtual machines or files).

In various embodiments of the present disclosure, systems and methods for enhanced searching, previewing, and querying of databases are provided. In various embodiments, the enhanced searching may allow for searching of various metadata items of the databases (e.g., table names, table schema information, indexed columns, columns with personally identifiable information (PII)), or other metadata) as well as various changes to the metadata items of the databases (e.g., changes to table schemas, deleted table names, changes to indexed columns, etc.). In various embodiments, a database may be quickly previewed (e.g., without having to mount and/or configure the database responsive to a user's request to view data from the database). For example, small portions of the tables (e.g., a limited number of rows) of a database may be stored (e.g., separately from the database itself) and may be accessed quickly and provided to a user upon a request to preview the table (e.g., after an enhanced search or at other suitable time). In various instances, the rows of the preview may be the most recently modified rows in the table (e.g., the preview may include rows that have been updated between a previous version of a backup of the database and the most recent version of the backup). The previews may significantly aid a user in determining whether the table is the table that the user was looking for and/or may help a user quickly ascertain the nature of a table (e.g., when deciding whether a database is to be backed up).

Typically, backup vendors keep a database backup in a format similar to the production format of the database. In some instances, a binary copy of the database data may be kept by backing up the storage (e.g., block level storage) of a machine (e.g., virtual machine) on which the database runs (and the backup may be restored and accessed by bringing up the virtual machine and querying the database through the virtual machine). In various instances, the database backup may be in a format set by the backup tool. For example, pg_dump keeps data tables in its own simple format when backing up a PostgreSQL database (e.g., a plain-text file containing SQL commands allowing reconstruction of the database or an archive file format that is used with pg_restore to restore the database).

In various embodiments, at least a portion of the databases of an organization (or various organizations that utilize a backup service) are backed up in a manner that allows the backups themselves to be queried very quickly (e.g., without requiring the database to be restored, mounted, and/or configured to service the query). For example, a database backup may be partitioned such that the records of the tables of the underlying database are stored in separate files that may be accessed in parallel responsive to a database query. In a particular embodiment, when a database is backed up, a table is identified, a column (e.g., primary key) for the table is identified, and the records of the table are grouped based on ranges of values in the records of the table for the primary key. The records for each group are then stored in separate Parquet files, with each Parquet file including records with values of the primary key within a range corresponding to that Parquet file. This process may be repeated for additional tables of the database (with a set of Parquet files being created for each table of the database assuming the respective table is large enough (e.g., over a threshold size) to warrant multiple Parquet files, otherwise the table could be stored in a single Parquet file). Metadata for the tables of the database (e.g., the schema, stored procedures, index information, views, etc.) may be stored in one or more files separately from but in association with the Parquet files. For example, the metadata may be stored in the same directory, physical storage device, or backend 106 as the Parquet files of the same table. The partitioned database backups may then be used as the basis for a fast query of the database or (in conjunction with the stored metadata) to restore the database.

In various embodiments, the resources that are backed up may comprise relational (e.g., SQL) databases (e.g., MySQL, PostgresSQL, SQL Server, Oracle Database, SQLite) and/or document based or other non-relational (e.g., NoSQL) databases (e.g., MongoDB, CouchDB, Firebase Firestore, RavenDB, Cassandra, Redis). In some instances, the resources may include virtual machines comprising such databases and/or other data. In some embodiments, the resources may include buckets that include various files.

In embodiments in which document based non-relational databases are to be backed up, data of the databases may first be translated into a tabular format, such that the data may be queried quickly and/or partitioned as described herein. In some embodiments, the format of the backups of the non-relational databases may be similar to the format of the backups of the relational databases, such that the backups of the non-relational databases and the relational databases may be searched together responsive to the same search query. In various embodiments, when a document based non-relational database is to be backed up, a collection of the database may be analyzed to determine which fields (also referred to as keys) appear frequently in the documents of the collection. Each of these fields is then represented in the backup by a column in a table, with each document of the collection represented in a row in the backup. For any fields of a record that are not selected for representation in a distinct column, the fields and corresponding values may be combined within an additional column in the table. Additional metadata may also be stored in the backup that may be used to restore the database to its original format using the metadata and the table of the backup. In some instances, depending on its size, the table may be split into multiple Parquet files.

Continuing the search example recited above, after a user has searched for and identified a target database, the user may submit SQL queries (or queries in another language, such as the native language of the database) to the database backup and view records returned from the database backup. In some embodiments, the user may also be allowed to write to the database backup as well through the same user interface used to read records from the database.

Some backup technologies may implement role based authentication, wherein control as to which data structures users can restore, backup, or view are based on the role. However, role based permissions are not based on data content and may not be granular enough to prevent problematic access. For example, a user with restore permission may accidentally restore a data structure to an unintended location. As one example, the user may restore a data structure having personal information to a region in which keeping the sensitive information is not allowed by law. As another example, the user may restore files with personal information to a location at which other users without the proper permissions may access them.

In various embodiments of the present disclosure, permissions to access backed up resources of an organization are based on content of the resources. Roles may be configured within the system and various access permissions set for the role may be conditional based at least in part on the content of the resources. When a user requests access to a resource, the role of the user may be identified, and the role may be examined to determine if the access type requested by the user is allowed for the role. Depending on the permissions granted, the access may be permitted, blocked, or partially fulfilled (e.g., by providing limited access, wherein certain content is blocked or obfuscated, while other content is made accessible to the user).

Various embodiments may provide one or more technical advantages such as faster identification of target data, faster and/or more efficient querying of data, decreased usage of computing and/or network resources when searching for and accessing target data or when applying access permissions, or other technical advantages. For example, when the table data is partitioned into multiple objects (e.g., where an object includes a Parquet file), the objects may be queried in parallel by a SQL database tool of a backend (e.g., Amazon Athena), thus significantly improving the speed of the query. Storing records of the database backups in Parquet files may also improve the portability of the backups (e.g., the Parquet files may be easily moved to a different backend 106 if the organization decides to switch service providers). As another example, providing roles with content-based access permissions may reduce computing resources utilized to protect content from unauthorized access, e.g., by leveraging a single data structure for a role defining access permissions for a plurality of users.

In the depicted embodiment, the cloud backup environment 100 includes a resource backup and search system 108. The resource backup and search system 108 may provide any suitable features of the resource backup, enhanced searching, database previewing, and/or resource access control described herein. In other embodiments, any of these features or a subset thereof may be performed by any other suitable logic, such as computing devices within one of the backends 106, by a computing device 102 (e.g., through a web application or native application that interfaces with the resource backup and search system 108), or by other suitable logic. For example, resource backup and search system 108 may generate database backups, a plurality of database metadata records that may be used in providing the enhanced searches, and a plurality of database preview records that may be used to provide database previews. The resource backup and search system 108 may receive requests from one or more computing devices 102 to backup databases or other resources and in response may generate database backups or other resource backups. The resource backup and search system 108 may also receive enhanced search requests from computing devices 102, identify search results in accordance with search terms of an enhanced search, provide enhanced search results to computing devices 102, receive requests for database previews from computing devices 102, provide database previews, and query the database backups. The resource backup and search system 108 may also be operable to restore databases from their database backups. The resource backup and search system 108 may also set permissions for roles based on input from users and control access to the backed up resources based on the role based permissions as described herein.

Resource backup and search system 108 may include any suitable number of computing devices to perform the functions described herein. In a particular embodiment, the resource backup and search system 108 may comprise a cluster of nodes (e.g., physical or virtual machines) in a Kubernetes environment, although any suitable computing environment may be used to implement the resource backup and search system 108. The resource backup and search system 108 may include and/or manage a plurality of accounts, where a particular account may be associated with (e.g., owned or controlled by) a particular organization. Data used to provide enhanced searching functionality, database preview, resource backup, fast database backup searching, or resource access control for a particular organization may be stored in the account owned by that organization. In various embodiments, the resource backup and search system 108 may be separate from the backends 106 or could be implemented (at least in part) within one of the backends 106.

Computing devices 102 may include any electronic computing device operable to receive, transmit, process, and store any appropriate data. In various embodiments, computing devices 102 may be mobile devices or stationary devices. As examples, mobile devices may include laptop computers, tablet computers, smartphones, personal digital assistants, and other devices capable of connecting (e.g., wirelessly) to network 104 while stationary devices may include desktop computers or other devices that are not easily portable. Computing devices 102 may include a set of programs such as operating systems (e.g., Microsoft Windows, Linux, Android, Mac OSX, Apple iOS, UNIX, or other operating system), applications, and other software-based programs capable of being run, executed, or otherwise used by the respective devices. A computing device may include at least one graphical display and user interface allowing a user to view and interact with applications and other programs of the computing device to perform operations associated with one or more resources (e.g., searching for resources, modifying resource contents, reading resource contents, initiating resource backups, setting access permission, etc.).

FIG. 1 also depicts a network 104 that couples the computing devices 102, backends 106, and resource backup and search system 108 together. The network 104 may transport communications between computing devices 102, the various backends 106, and the resource backup and search system 108.

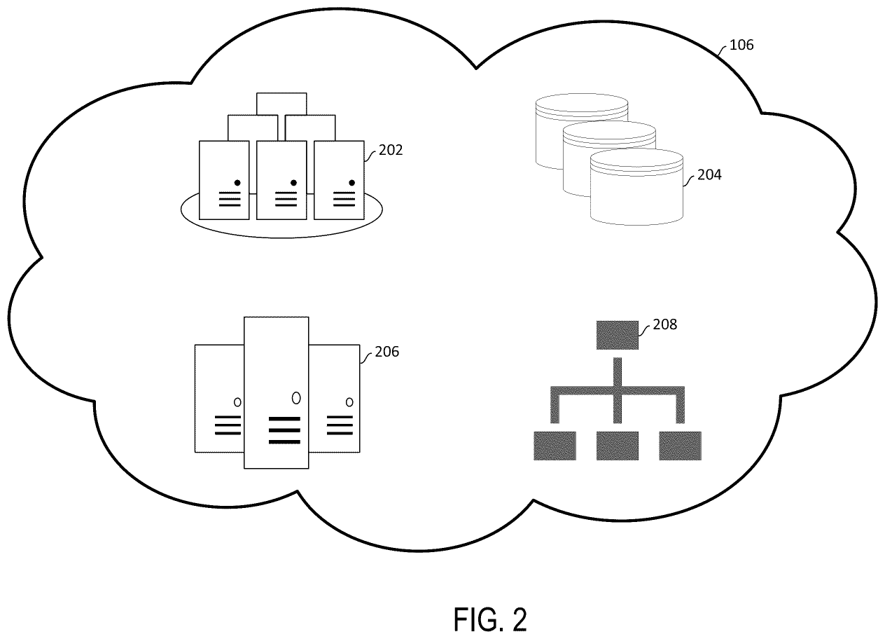

FIG. 2 illustrates a block diagram of a backend 106 of a cloud backup service provider of the environment of FIG. 1, in accordance with any of the embodiments disclosed herein. Backend 106 may include various computing systems to provide services (including resource backup services) to various organizations. In the embodiment depicted, backend 106 includes compute resources 202, storage resources 204, operations computing systems 206, and networking resources 208.

Compute resources 202 may include hardware components used to provide cloud services, such as general-purpose processors (e.g., central processing units (CPUs), server processors, accelerated processing units (APUs), controllers), specialized processors (e.g., graphics processing units (GPUs), application-specific integrated circuits (ASICs), digital signal processors (DSPs), field programmable gate arrays (FPGAs), neural network processing units (NPUs), data processor units (DPUs), controller cryptoprocessors (specialized processors for cryptographic algorithms)), or accelerators (e.g., graphics accelerators, compression accelerators, artificial intelligence accelerators), or other hardware components.

Storage resources 204 may provide the storage and retrieval of data (e.g., databases (including backups) or associated data). Storage resources 204 may include hardware, such as hard disk drives, solid-state drives, tape storage, or other suitable mechanisms for storing data. Storage resources 204 may store any suitable data in any suitable format(s). For example, storage resources 204 may provide object, block, or file storage. In various embodiments, storage resources 204 may include one or more database management systems (DBMS), such as relational databases (e.g., MySQL, PostgresSQL, SQL Server, Oracle Database, SQLite) and NoSQL data bases (e.g., MongoDB, Cassandra, Redis).

Operations computing systems 206 may include any suitable computing systems to manage the various operations of the backend, such as coordination of incoming and outgoing communications; allocation of compute, storage, and networking resources; monitoring of usage; application deployment; enforcement of security (e.g., identity and access management (IAM), encryption and key management, intrusion detection), and other management tasks.

Networking resources 208 may include any suitable hardware or software to facilitate communication among compute resources 202, storage resources 204, and/or other cloud resources of the backend. Networking resources 208 may include, e.g., routers, switches, firewalls, load balancers, gateways, edge devices, network interface cards, and other suitable networking hardware.

The compute resources 202, storage resources 204, and networking resources 208 may be used to provide compute services to clients of the service provider, such as virtual machines, containers, bare metal servers, or serverless computing.

In various embodiments, a backend 106 is managed by a third party. For example, a backend 106 may be deployed using a cloud service such as Amazon Web Services, Microsoft Azure, or Google Cloud Platform. A backend 106 may provide services to organizations using any suitable service model, such as infrastructure as a service (IaaS), platform as a service (PaaS), or software as a service (SaaS), or combinations thereof.

In IaaS, on-demand access is provided to essential information technology (IT) infrastructure, such as servers, storage, and networking, over a virtual interface. Users do not need to manage or maintain physical infrastructure, as it is hosted and managed by the cloud service provider. While the provider handles the underlying hardware and maintenance, users retain control over operating systems, storage, and applications they deploy. This eliminates the need for organizations to manage on-premises infrastructure, offering flexibility and scalability.

In PaaS, a development and deployment environment is provided, including the necessary infrastructure and software tools, for creating and managing applications. Users can develop and run cloud-based applications without managing the underlying infrastructure, such as servers, networks, and storage. PaaS is typically accessed on a pay-as-you-go basis and allows users to focus on application deployment and management, while the cloud provider handles the infrastructure and software maintenance.

In SaaS, users access cloud-based applications provided and maintained by a service provider. Instead of installing software locally, users access the applications via the web or application programming interface (API) on a subscription basis. In this model, the service provider oversees the hardware, software, middleware, and security, eliminating the need for end users to manage or update the software themselves.

An organization may utilize one or more backends 106 to provide resource backup for the organization. Resource backup is the process of creating a copy of the data of a resource that can be used to restore the resource in case of data loss, corruption, or other disasters. Backups are essential for data protection, disaster recovery, and ensuring business continuity.

Various types of backups may be performed on the resources of an organization. In a full backup, a complete copy of the entire resource (e.g., database) is saved in the backup storage. This is the most comprehensive type of backup but can be time consuming and storage intensive. In an incremental backup, only the data that has changed since the last backup (either full or incremental) is saved in the backup storage. This reduces the amount of data to be backed up and speeds up the backup process. In a differential backup, all of the data that has changed since the last full backup is saved in the backup storage. This is faster than a full backup but can grow in size over time until the next full backup. In a transaction log backup, all of the transactions that have occurred since the last transaction log backup are saved in the backup storage. This is often used with full and differential backups to provide point-in-time recovery. This type of backup may utilize less space than other backup options but may require a long time to restore data from the backup storage.

An organization may utilize various backup strategies (and could utilize different backup strategies for different databases). For example, in a full backup strategy, full backups are regularly performed. This strategy may be suitable for small databases where backup time and storage size are not significant concerns. In an incremental backup strategy, a full backup may be performed periodically (e.g., weekly) and incremental backups are performed more often (e.g., daily). This reduces backup time and storage requirements. In a differential backup strategy, a full backup is performed periodically (e.g., weekly) and differential backups are performed more often (e.g., daily). This strategy provides a balance between backup time and storage. In a mixed strategy, various types of strategies (e.g., full, incremental, and transaction log backups) may be combined to optimize backup and recovery times.

When backing up databases, an organization may utilize any suitable database backup product to implement their desired backup strategies and to create database backups that are stored on a backend 106 or other location. Various commercially available products include, e.g., Oracle RMAN (Recovery Manager), Microsoft SQL Server Backup, MySQL Enterprise Backup, pg_dump, pg_basebackup, IBM Db2 Backup, Veritas NetBackup, Veeam Backup & Replication, and Commvault.

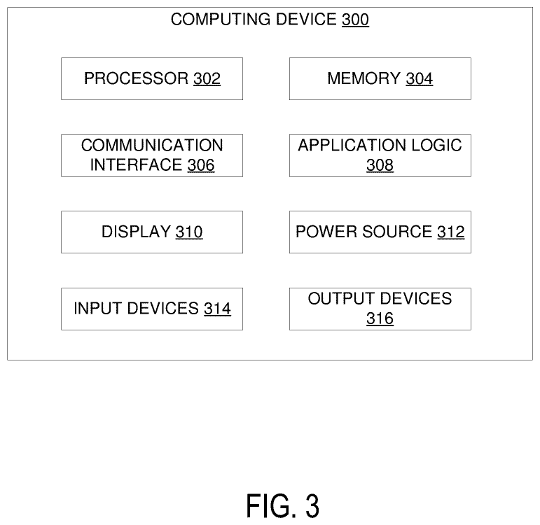

FIG. 3 illustrates a block diagram of a computing device 300, in accordance with any of the embodiments disclosed herein. One or more computing devices 300 (or portions or alternatives thereof) may be used to implement a computing device 102, one or more portions of resource backup and search system 108, or one or more portions of backends 106. As used in this document, the term computing device is intended to encompass any suitable processing device. A computing device 300 may be operable to receive, transmit, process, store, or manage data and information associated with cloud backup environment 100.

In the depicted embodiment, computing device 300 includes one or more processors 302, memories 304, communication interfaces 306, application logic 308, display 310, power source 312, input devices 314, and output devices 316, among other hardware and software. These components may work together in order to provide any suitable functionality described herein.

A processor 302 may be any suitable computing device, resource, or combination of hardware, stored software and/or encoded logic operable to provide, either alone or in conjunction with other components of computing device 300, the functionality of the computing device. In particular embodiments, computing device 300 may utilize multiple processors to perform the functions described herein. In various embodiments, processor 302 may include one or more general-purpose processors (e.g., CPUS, server processors, APUs, controllers), specialized processors (e.g., GPUs, general-purpose GPUs, ASICs, DSPs, FPGAs, NPUs, DPUs, controller cryptoprocessors (specialized processors for cryptographic algorithms)), or accelerators (e.g., graphics accelerators, compression accelerators, artificial intelligence accelerators).

A processor can execute any type of instructions to achieve the operations detailed in this specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array (FPGA), an erasable programmable read only memory (EPROM), an electrically erasable programmable ROM (EEPROM)) or an application specific integrated circuit (ASIC) that includes digital logic, software, code, electronic instructions, or any suitable combination thereof.

Memory 304 may comprise any form of non-volatile or volatile memory including, without limitation, random access memory (RAM), read-only memory (ROM), magnetic media (e.g., one or more disk or tape drives), optical media, solid state memory (e.g., flash memory), removable media, or any other suitable local or remote memory component or components. Memory 304 may store any suitable data or information utilized by a computing device 300, including software embedded in a (e.g., non-transitory) computer readable medium, and/or encoded logic incorporated in hardware or otherwise stored (e.g., firmware). Memory 304 may also store the results and/or intermediate results of the various calculations and determinations performed by processor 302.

Communication interface 306 may be used for the communication of signaling and/or data between computing devices and one or more networks and/or network nodes coupled to a network or other communication channel. For example, communication interface 306 may be used to send and receive network traffic such as data packets. Each communication interface 306 may send and receive data and/or signals according to a distinct standard such as an LTE, IEEE 802.11, IEEE 802.3, or other suitable standard. In some instances, communication interface 306 may include antennae and other hardware for transmitting and receiving radio signals to and from other devices in connection with a wireless communication session over one or more networks.

Application logic 308 may include logic providing, at least in part, the functionality of the computing device. In a particular embodiment, the logic of a computing device 300 may include software (e.g., a web browser, an application, an operating system, etc.) that is executed by processor 302. However, “logic” as used herein, may include but not be limited to hardware, firmware, software and/or combinations of each to perform a function(s) or an action(s), and/or to cause a function or action from another logic, method, and/or system. In various embodiments, logic may include a software controlled microprocessor, discrete logic (e.g., an application specific integrated circuit (ASIC)), a programmed logic device (e.g., a field programmable gate array (FPGA)), a memory device containing instructions, combinations of logic devices, or the like. Logic may include one or more gates, combinations of gates, or other circuit components. Logic may also be fully embodied as software.

Display 310 may include one or more embedded or connected (e.g., via a wired or wireless connection) external visual indicators, such as a computer monitor, a touchscreen display, a liquid crystal display (LCD), a light-emitting diode display, or a flat panel display.

Power source 312 may include one or more energy storage devices (e.g., batteries or capacitors) and/or circuitry for coupling components of the computing device 300 to an energy source separate from the computing device 300 (e.g., alternating current line power).

An input device 314 may accept input from a source external to the computing device 300. Examples of input devices 314 may include an image capture device, keyboard, cursor control device, touchscreen, and an audio device (e.g., microphone), to name a few.

An output device 316 may output signals based on information provided by computing device 300. Examples of output devices 316 include an audio device (e.g., a speaker), an audio codec, a video codec, a printer, a transmitter for providing information to other devices, a storage device, to name a few.

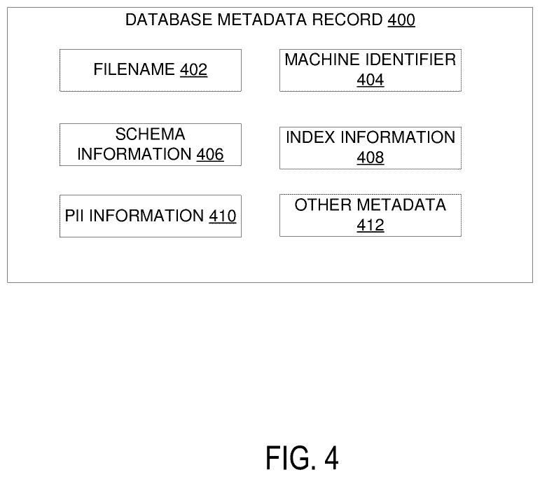

FIG. 4 illustrates an example database metadata record 400, in accordance with any of the embodiments disclosed herein. As alluded to above, enhanced database searching may allow for easier identification of databases and database resources (e.g., tables, columns, or other database portions) based on various types of metadata.

In various embodiments, database metadata records 400 are generated for all or a portion of the databases of an organization (e.g., backed up databases, databases that aren't backed up, databases with multiple versions, etc.) and the database metadata records 400 are stored in a central location (e.g., in the same database file, folder, or bucket; as associated objects; etc.). In some embodiments, the database metadata records 400 are stored within resource backup and search system 108, a backend 106, or other suitable location.

In the embodiment depicted, database metadata record 400 includes file name 402, machine identifier 404, schema information 406, index information 408, PII information 410, and other metadata 412. In other embodiments, any one or more of these metadata items may be omitted.

File name 402 may include, e.g., an alphanumeric string that identifies a name of a database. The filename may also include an extension based on the type of database file (e.g., .db, .sqlite, .mdb, .accdb, .sql, etc.). In some instances, the file name 402 may also include a file path.

Machine identifier 404 may include an identifier of a physical or virtual computing system (e.g., a server) associated with the database. For example, in a physical environment the machine identifier may include an identifier of a physical machine. As another example, in a cloud or virtual environment, the machine identifier may include the name of a virtual machine on which the database is running (e.g., if the database is used in an infrastructure as a service environment) or the name and/or address of a database if the database is run by a managed database service and the infrastructure on which the database runs is unknown. For example, the machine identifier 404 may include a machine name and/or a network address (e.g., an Internet Protocol (IP) address). The computing system may be in a private cloud of the organization, in a backend 106, or other suitable location.

Schema information 406 may specify a structure that defines how data is organized within the database. The schema information 406 may define the logical configuration of various portions of the database (e.g., tables, columns, relationships, keys, indexes, constraints). The schema may define how the data is stored, accessed, and managed. Various examples of schema information 406 are described below. In some examples, the schema information 406 may include any combination of the following.

In an example, the schema information 406 includes names of tables in the database. A table may be a structured collection of related data organized in rows and columns. Each row (also referred to as a record) may represent a single entry in the table (e.g., in a “Students” table, each row might represent an individual student), while each column (also referred to as field or attribute) may represent a specific attribute of the data (e.g., in a “Students” table, columns could include “StudentID”, “FirstName”, “LastName”, “Address”, etc.).

In an example, the schema information 406 includes the names of the columns in each table. In another example, the schema information 406 includes the data types of the columns (e.g., integer, varchar, date, Boolean, etc.) that defines the kind of data stored that can be stored in the respective columns.

In another example, the schema information 406 includes one or more relationships between tables. For example, the schema information 406 may include identification of one or more keys, such as a primary key and/or one or more foreign keys. A primary key may be a column (or set of columns) that uniquely identifies each row in a table. The primary key may ensure that no two rows have the same values for the primary key and that these values are not null. Continuing the example above, the “StudentID” column may be the primary key for the “Students” table.

A foreign key is a column (or set of columns) that creates a relationship between two tables by referring to the primary key. A foreign key helps maintain referential integrity, ensuring that data in one table corresponds to valid data in another table. A foreign key in one table may point to the primary key of another table. For example, a foreign key may specify a column in a first table that references a column in a second table, thus constraining the values for the column in the first table to the set of values for the column in the second table. Thus, the foreign key constraint may prevent invalid data from being inserted into the foreign key column since the value inserted has to be one of the values contained in the table with the primary key.

In another example, the schema information 406 includes column constraints. The constraints may include rules that are applied to ensure data integrity. For example, a constraint may require row values for a column to be unique or not null. As another example, a constraint may enforce a condition that must be met for a value to be allowed in a column (e.g., to limit the range or type of data that can be entered).

Database metadata record 400 also includes index information 408. The index information 408 includes indications of which column(s) of the table(s) in the database have been indexed, where the indexing operation enables quicker searching for rows with specific column values. In some embodiments, an index may use a binary tree search with the data in the leaf nodes of the tree (e.g., the index may be stored in a binary tree). In some instances, other data structures may be used to implement an index, such as R-trees, hash indexes, inverted lists, etc.). An index may be a single column index or a composite index (a combination of multiple columns).

Database metadata record 400 also includes PII information 410. PII may include information about an individual that can be used to uncover that individual's identity or other sensitive information associated with that individual. Categories of PII may include, e.g., personal details (including information types such as full name, email address, phone number), unique identification numbers (including information types such as driver's license numbers, government-issued ID numbers, social security numbers), biometric data (including information types such as fingerprint, retinal scan data, other biological characteristic), financial information (including information types such as bank account numbers, credit card numbers, debit card numbers), medical records, or other sensitive information.

In one example, the PII information 410 may include indications of which columns include PII information (e.g., a list of the names of the columns that include PII, a binary indication for each column as to whether the column includes PII, etc.). As another example, for columns that include PII, the PII information 410 may additionally or alternatively include an indication of the category and/or type of PII for each column.

Database metadata record 400 may include other metadata 412, which may include any suitable metadata not mentioned above. For example, other metadata 412 may include a summary of column information, e.g., an indication of what type of information is stored in the column (e.g., credit card numbers, emails, locations, etc.) or a value obtained from performing an operation on the values in the column (e.g., an average value). As another example, other metadata 412 may include sizes of tables (e.g., number of rows, number of columns, total content size, or other suitable size information).

The database metadata record 400 may include the most current metadata for the database (e.g., the filename, machine identifier, schema information, index information, PII information, or other metadata for the latest version of the database, which may also be the most recent backup of the database). In various embodiments, the database metadata record 400 may additionally or alternatively include changes that have occurred to the metadata across various versions of the database. For example, the database metadata record 400 may include all of the changes that have occurred from the first version of the database to the most current version of the database or any subset thereof (e.g., the changes that have occurred in the last N versions of the database or over a certain time period).

The database metadata record 400 may include any suitable changes to the metadata. For example, database metadata record 400 may include tables, columns, and indexes that have been added, dropped, or edited (e.g., through a name or other parameter change) across multiple versions of the database. As another example, database metadata record 400 may include other changes to the schema, such as creation, deletion, or changes to primary or foreign keys. As another example, database metadata record 400 may include columns with PII information that have been added, dropped, or edited.

The changes may be stored in the database metadata record 400 in any suitable manner. For example, the database metadata record 400 may include an initial collection of the metadata and a list of the changes specifying when the changes were made and/or in which version of the database the changes were made. As another example, the database metadata record 400 could include a collection of the metadata for each version (or a subset of the versions) of the database that is backed up and the changes may be ascertained by comparing the collections against each other (where a timestamp and/or version number may also be stored for each different version).

The database metadata record 400 may be updated at any suitable time. In some instances, the database metadata record 400 is updated responsive to a backup of a database (e.g., after determining that at least one change to the metadata is present in the backup relative to the previous backup). Additionally or alternatively, a database may be periodically checked to determine whether the corresponding database metadata record 400 is to be updated. For example, the databases of an organization may be periodically scanned and/or accessed to determine whether the database metadata record 400 should be updated.

The collection of database metadata records 400 of an organization may be stored at any suitable location. For example, a database metadata record 400 may be stored with (e.g., in the same physical storage device) as the associated database backup(s). As another example, a database metadata record 400 may be stored in the same backend 106 as the associated database backup(s). As yet another example, a database metadata record 400 may be stored in a separate location from the associated database backup(s) (e.g., database metadata records 400 could be stored in a system of the resource backup and search system 108 or in a private cloud of the organization) so as to make searching of the collection of database metadata records 400 faster. As described above, in some embodiments, the database metadata records 400 are aggregated together into the same database file, directory, or other data structure that is accessed when an enhanced search is performed.

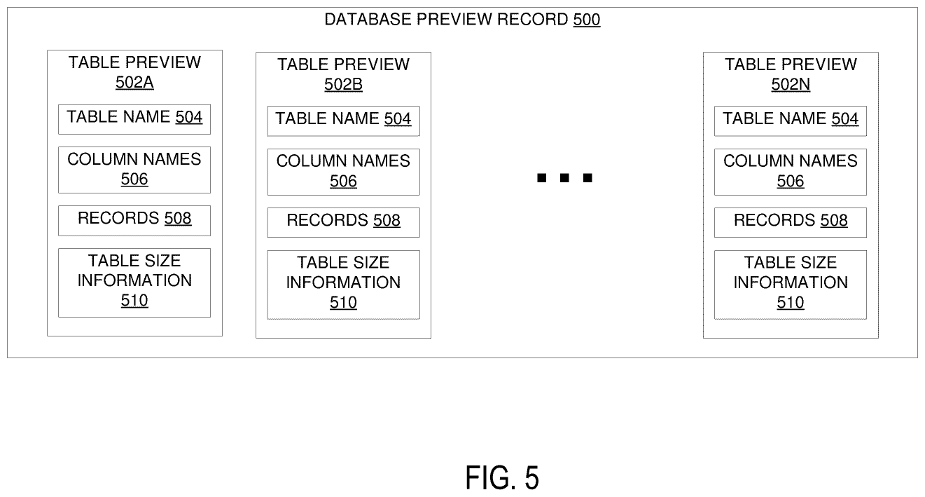

FIG. 5 illustrates a database preview record 500, in accordance with any of the embodiments disclosed herein. A database preview record 500 may include a variety of information for one or more tables of the database corresponding to the particular database preview record 500. In the embodiment depicted, the database preview record 500 includes a table preview 502 (e.g., 502A, 502B, . . . , 502N) for each table of the database. A table preview 502 includes table name 504, column names 506, records 508, and table size information 510.

Table name 504, column names 506, or table size information 510 may be similar or equivalent to the table name, column names, or table size information that may also be included in schema information 406 or other metadata 412. In some instances, the database preview record 500 may leverage portions (e.g., table name 504, column names 506, or table size information 510) of the database metadata record 400. For example, a single copy of any of these may be stored and utilized in both database metadata record 400 and database preview record 500. As another example, a single instance of any of these may be ascertained from a database (e.g., from a snapshot or the database itself as described below) and then stored in both the database metadata record 400 and the database preview record 500.

Records 508 include values for the columns of the table. A record (also referred to as a row) may include a value for each column (or a null value if applicable). In some instances, a record may include an obfuscated value for a column (or multiple obfuscated values for multiple columns). For example, if a column of a table includes PII (e.g., that should not be visible to the backup administrator and/or other users of the organization), the values of the column are obfuscated. Thus, sensitive PII information (e.g., credit card numbers, social security numbers, etc.) is not included in the table preview 502, but rather some obfuscated version of the data is stored in the table preview 502. The data may be obfuscated in any suitable manner. For example, the data may be encrypted, the data may be replaced with a predetermined value (e.g., all ones, all zeros, all asterisks, etc.), or the data may be replaced with a null value.

In some instances, the level of data obfuscation for the previews may be user configurable (e.g., an administrator or other user of the organization could provide the types of data that are to be obscured to the resource backup and search system 108 for use in generating the table previews 502). In one embodiment, even absent user input, the system may enforce a default level of obfuscation (e.g., the system may obfuscate data in accordance with one or more privacy standards, such as the General Data Protection Regulation (GDPR) or Health Insurance Portability and Accountability Act (HIPAA)). The selection of the data to be obfuscated may, in some instances, be based on the type of data stored in the columns (e.g., as recorded in PII information 410 of a corresponding database metadata record 400).

In some embodiments, multiple different levels of obfuscation may be implemented. In one example, multiple versions of the table preview 502 may be kept, with different columns obfuscated in the various versions. The various versions may be provided to users based on privilege levels associated with the users. For example, only users with a particular privilege level are allowed to view a version of the preview 502 in which PII is not obfuscated. As another example, a user with a lowest privilege level may be presented with a version of the preview 502 that has the most columns obfuscated. In some embodiments, one or multiple versions may utilize different cryptographic keys associated with various privilege levels that may be used to decrypt PII that is encrypted within the one or more versions of the table preview 502 to implement different levels of obfuscation. In various embodiments, the privilege level of a user may be set within a role of that user, as described below.

Unless the corresponding table is very small, the records 508 of the table preview 502 are a subset (e.g., a very small subset) of the records of the table. For example, the number of records 508 in each table may be equal to or less than a fixed number of records (e.g., 25 records, 50 records, 100 records, 200 records, etc.). In some examples, the number of records 508 of a table preview 502 may be limited to the number of records that keeps the data size of the records 508, table preview 502, or database preview record 500 under a threshold data size (e.g., 0.5 MB, 1 MB, 2 MB, 5 MB, etc.). Limiting the size of the previews in this manner may reduce the required storage and allow the previews 502 to be communicated to users relatively quickly (especially compared to mounting and querying the database). In some instances, the number of records included in the previews may be user configurable (e.g., an administrator of the organization could provide the threshold to the resource backup and search system 108 for use in generating the table previews 502).

In various embodiments, the table previews 502 of a database preview record 500 may include previews for multiple versions of one or more of the tables of a database. For example, for a first version of a database (e.g., backed up at a first point in time) the database preview record 500 may include table previews 502 for each of the tables of the first version of the database, for a second version of the database (e.g., backed up at a second point in time) the database preview record 500 may include table previews 502 for each of the tables of the second version of the database (which may include the same tables as in the first version of the database or one or more of the tables may be omitted or added from the second version). The database preview record 500 may include any number of table previews for different versions of the tables. Such embodiments may be helpful if a schema for one or more tables has been changed between versions.

In some embodiments, a table preview 502 for a particular table version may include its own copy of metadata and data (e.g., records 508) or may share metadata and data with a table preview 502 for another table version (e.g., to conserve storage space). For example, a table preview 502 for a particular table version could include the table name 504, column names 506, records 508, or table size information 510 or could include one or more references to the table name 504, column names 506, records 508, table size information 510, or portions thereof. In some instances, a table preview 502 of a particular table version may simply include indications of any changes to the metadata or data relative to a table preview 502 of another table version (and thus the preview that is shown to a user may be constructed by accessing the other table preview and editing the preview based on any indicated changes). Other suitable arrangements of storing the various previews is contemplated herein.

In some embodiments, table previews 502 of different versions of the same table may include different samples of data (e.g., records 508) of the table (e.g., including data that has been updated since the previous version of the database). In some embodiments, the data may overlap in whole or in part, e.g., if edits to the table were minimal from version to version.

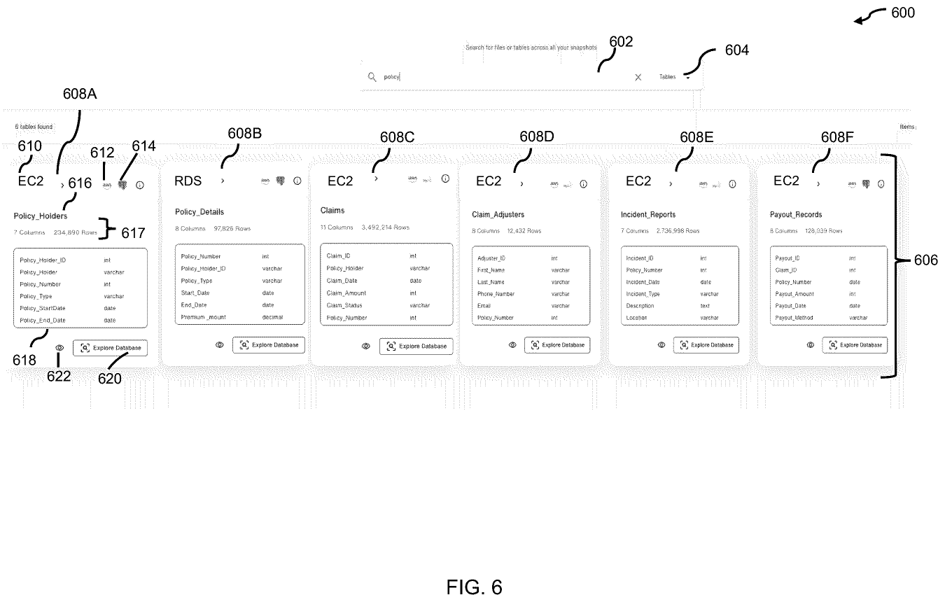

FIG. 6 illustrates an enhanced database search interface 600, in accordance with any of the embodiments disclosed herein. In this embodiment, the enhanced database search interface 600 is provided through a web application (e.g., accessed through a web browser executed by a computing device 102), but could also be provided through a native application or by other suitable means.

The enhanced database search interface 600 includes a search bar 602 and a search category selector 604. A search expression is entered into the search bar 602 and a search category is selected via search category selector 604. In one embodiment, the search category selector 604 may allow for a file system search or a database search. In one example, the file system search may perform a search for files in a file system that match the search expression, while the database search (depicted in search category selector 604 as “Tables”) may return results in which table names or contents thereof (e.g., column names, data within the table, etc.) of databases match the search expression. In the embodiment depicted, a database search is selected.

The search expression may be any combination of characters, words, operators, and/or symbols. The enhanced database search interface 600 may support any one or more types of searches, such as exact match searches, fuzzy searches (e.g., approximate matching), keyword stemming searches (e.g., the search result includes but is not an exact match with the searched term), synonym searches, semantic searches (a search engine technology that analyzes the meaning of words and phrases to return results that match the intent of a query, rather than just matching words), Boolean searches, wildcard searches, regular expressions searches, natural language searches, or any suitable combinations thereof. In various embodiments, the enhanced database search interface 600 may allow the user to specify the type(s) of search that is to be used. As one example, a user may select between an exact match search and a keyword stemming search. As another example, a user may select between an exact match search and a semantic search.

In the embodiment depicted, a user has entered “policy” into the search bar 602 as the search expression. A search results window 606 displays results 608 (e.g., 608A-F) returned by the search. In the depicted embodiment, the results include representations of tables that include either a table name or a column name that includes the search expression. For example, result 608A represents a table (Policy_Holders) that also includes columns (Policy_Holder_ID, Policy_Holder, Policy_Number, Policy_Type, and Policy_StartDate) that include the search expression “policy”; result 608B similarly includes the search expression in the name of the table and the names of various columns, result 608C includes the search expression in the name of at least one of its columns (Policy_Holder), result 608D may include the search expression in the name of at least one of its columns (e.g., one of the column names that is not shown), result 608E includes the search expression in the name of at least one of its columns (Policy_Number), and result 608F includes the search expression in the name of at least one of its columns (Policy_Number).

A result may include any suitable information about the database resource (e.g., the database itself or portion thereof such as a table, column, or other portion) represented by the result. For example, result 608A displays service type 610, service provider 612, database type 614, table name 616, size information 617, and field preview 618. Other embodiments may include different combinations of this information and/or other information about the resource.

Service type 610 may indicate the service that hosts the resource. In this instance, the service type is Amazon's Elastic Compute Cloud (EC2), indicating that the database that includes the resource is running inside of a virtual machine managed by the organization. As a contrast, in result 608B, the service type is Amazon's Relational Database Service (RDS), indicating that the database that includes the resource is within a managed database service.

Service provider 612 indicates an entity that provides the service that stores the database or database backup (e.g., the provider of the backend, private cloud, or other service). In each of the displayed results, the service provider is Amazon Web Services (AWS). In some embodiments, service provider 612 may include an icon. In some instances, the service provider could be the organization itself or a service associated with the organization (e.g., if the database is stored locally).

Database type 614 indicates a type of the database that includes the resource. For example, results 608A, 608C, 608D, and 608E display an icon that represents PostgresSQL while results 608B and 608F display an icon that represents MySQL.

Table name 616 is the name of the table that matched the search (in this instance because either the name of the table matched the search expression or the name of a column of the table matched the search expression).

Size information 617 may include any suitable information about the size of the resource. In the depicted embodiment, the size information 617 includes the number of columns and the number of rows in the table.

Field preview 618 may include information about the fields of the resource. In the embodiment depicted, field preview 618 includes the names of the first five columns of the table as well as the data type for each of the columns. In other embodiments, field preview 618 may include any number of column names.

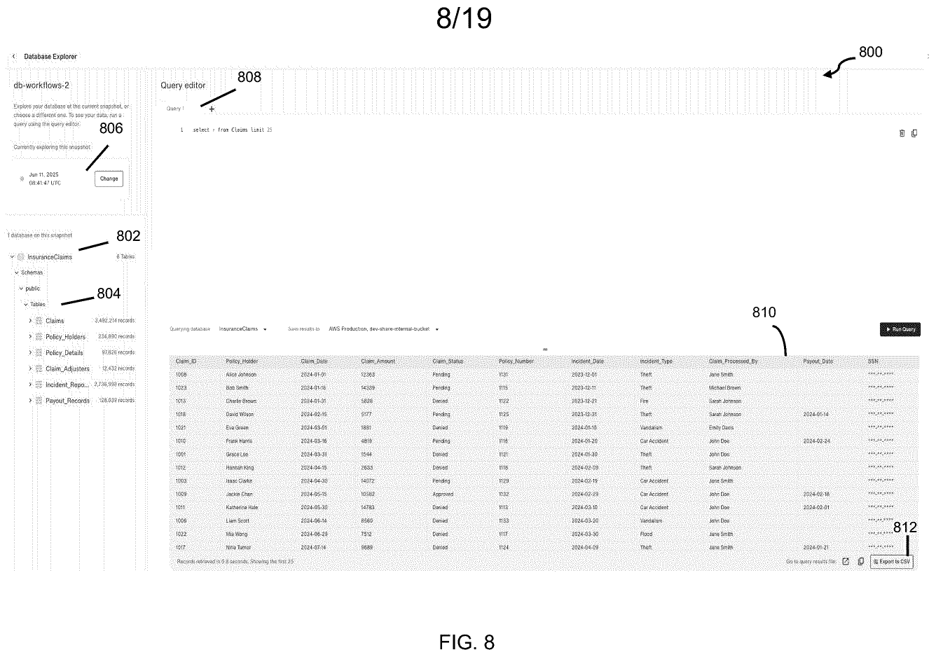

A result 608 may also include a database explorer option 620 that a user may select to view metadata about the database that includes the resource and/or the actual database contents. In some embodiments, the results 608 may only include metadata, while the information returned through the interface provided after the database explorer option 620 is selected may additionally include database contents (e.g., field values, records, etc.). A database explorer interface is described in more detail in connection with FIG. 8.

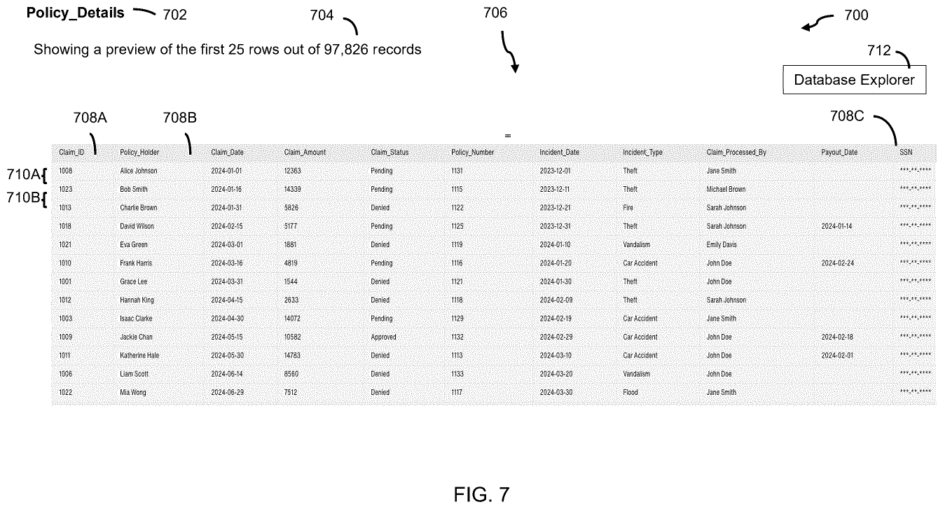

A result 608 may also include a database preview option 622 that a user may select to view a preview of a database resource (e.g., a table). In various embodiments, when the database preview option 622 is selected, a preview interface is displayed. The preview interface is described in more detail in connection with FIG. 7.

In other embodiments, the results 608 may include any suitable information. For example, a result 608 could include the latest version number of the database of the resource, a date that the database was backed up, an indication of whether the resource includes PII, indications of which columns include PII, edits made to the resource (e.g., which tables or columns were added, dropped, or otherwise changed relative to a different version), other metadata described herein (or changes thereto), or other suitable information.

In various embodiments, the enhanced database search interface 600 may provide any number of filtering options. Using the enhanced database search interface 600, the user may specify which filtering options are to be applied to the search. In various embodiments, the filtering options is used in combination with the search expression in the enhanced search and the results presented via the enhanced database search interface 600 are limited to those matching the filtering options as well as the search expression.

In one example, a search may be filtered by database backup source. For example, the enhanced database search interface 600 may include an option to select one or more sources (e.g., a private cloud, any one or more of backends 106) that are to be included in the search. In some instances, all sources may be selected (either explicitly or by default).

In another example, a search may be filtered to only include one or more types of metadata. For example, the search may be limited to any suitable selection of one or more of file names, machine identifiers, table names, column names, keys, indexes, columns including PII information, or any of the other metadata types referenced herein. In such embodiments, the search expression may be compared against the selected type(s) of metadata to find resources that match the search expression.

In another example, a search may be limited to metadata for the current database backup version for the databases. In another example, a search may be limited to metadata that was part of a change made in a database backup, such as an addition, deletion, or other edit. For example, such an embodiment may be useful when a user is trying to identify when a particular table or column (or other metadata) was added or deleted from a database. In yet another example, the search may include both the metadata for the most recent backup version as well as any changes to the metadata across any number of versions of backups (e.g., all or a subset thereof, such as the last N backups or backups made during a specified date range).

In another example, a search may be limited to a particular date range. For example, the search results may be limited to backups made within that date range.

In another example, a search may be limited to a particular size. For example, the search may be limited to tables with less than N rows, between N and M rows, or greater than N rows (where N and M may be any suitable integers provided by the user). As another example, the search may be limited to tables with less than N columns, between N and M columns, or greater than N columns.

The enhanced database backup searching methods and systems described herein may enable various use cases. Any one or more of the embodiments described herein may enable one or more of the following use cases. In a first use case, a user may search for databases and/or tables with column names that identically match a search expression. In a second use case, a user may search for databases and/or tables that include column names in which a search expression is a portion of the column name. In a third use case, a user may perform a semantic column name search (e.g., a search for a column including “last_name” may return databases with tables that have columns including “family_name”). In a fourth use case, a user may search for columns with certain types or categories of PII data. For example, a user may search for tables that include columns with credit card numbers or financial information. As another example, a user could simply search for tables with columns that include PII data. In a fifth use case, the user may search for a table that has had a particular column (matching the search expression) removed. In a sixth example, the user may search for a table that has had a particular column removed within a specified date range. In a seventh example, a user may search for all databases that are not being backed up and may view a plurality of previews to determine which databases to back up. In an eighth example, a user may view a plurality of previews to determine which databases to restore from a backup stored remotely (e.g., responsive to local deletion of one or more of the databases).

FIG. 7 illustrates a database preview interface 700, in accordance with any of the embodiments disclosed herein. The database preview interface 700 may be displayed by the same device (e.g., a computing device 102) as the enhanced database search interface 600. In this embodiment, the database preview interface 700 is provided through a web application (e.g., accessed through a web browser executed by a computing device 102), but could also be provided through a native application or by other suitable means.

In some instances, the database preview interface 700 may be displayed responsive to a selection of a result (or an option within a result) of a search as described above. In other embodiments, the database preview interface 700 may be displayed responsive to other suitable action (e.g., selection of a database resource from an inventory of available database resources).

In the embodiment depicted, database preview interface 700 includes a name 702 of the selected table, size information 704 (in this instance, the size information 704 includes the number of records in the table as well as the number of records that are displayed in the preview).

The database preview interface 700 displays a database preview 706. The database preview 706 includes column names 708 (e.g., 708A, 708B, 708C, and so on). The database preview 706 includes records 710 (e.g., 710A, 710B, and so on). Each record 710 includes a value (or a null value) for each column. For example, the record 710A includes a value of 1308 for the column Claim_ID, a value of Alice Johnson for the column Policy_Holder, and so on. In the embodiment depicted, the column SSN includes PII, and thus the values in this column are obfuscated (e.g., represented by asterisks) to prevent disclosure of this information to the user.

The database preview interface 700 also includes a database explorer option 712 that a user may select to view metadata about the database that includes the table previewed by the database preview interface 700 and/or data from the tables of the database. For example, after a user previews the database and determines that it is the database the user is looking for the user may select the database explorer option 712 to view additional information from the database or to perform other database operations.

Although not shown, in some embodiments, database preview interface 700 may include a version selector. When multiple versions of a database have been backed up (e.g., at different points in time), the user may select which version to preview. For example, a version slider may be presented in the database preview interface 700 that the user may use to select the version associated with the table preview that is to be shown. In a particular embodiment, the version slider may be arranged from the older version on one side to the newest version on the other side. In some embodiments, the latest version of the table may be selected by default.

FIG. 8 illustrates a database explorer 800, in accordance with any of the embodiments disclosed herein. The database explorer 800 may be displayed by the same device (e.g., a computing device 102) as the enhanced database search interface 600 or database preview interface 700. In this embodiment, the database explorer 800 is provided through a web application (e.g., accessed through a web browser executed by a computing device 102), but could also be provided through a native application or by other suitable means.

The database explorer 800 includes a navigation menu on the left which includes a database name 802 and table names 804 of the tables in the database (as well as corresponding table size information including the number of records of each table). The database explorer 800 may also include a version selector 806. When multiple versions of a database have been backed up, the user may select which version to perform database operations on (e.g., which version to send SQL or other queries to). For example, in the embodiment depicted, each version may be distinguished by the point in time at which the database was backed up. In some embodiments, the latest backup version may be selected by default.

Once a user has selected a version, the user may enter a query in the query interface 808. The query may initiate an access to the backup (e.g., Parquet files storing the records of one or more tables of the selected version of a partitioned database backup) to read from or write to the tables. The query interface 808 may support any suitable SQL queries, such as SELECT queries to return records from one or more tables, INSERT INTO queries to insert new records into a table, UPDATE queries to modify existing records in a table, DELETE queries to delete existing records in a table, CREATE VIEW queries to create a view, ALTER TABLE queries to add or delete a column or to change the data type of a column, CREATE to create a new table, or other suitable SQL queries. In some embodiments, the query interface 808 may support commands that read from tables but not commands that edit tables, so as to not allow changes to the records of the partitioned backup.

In the embodiment depicted, the user has entered the SQL query “select * from claims limit 25” to select the first 25 records of the “Claims” table. Data read from the relevant Parquet file(s) of the database via a query may be displayed in the results interface 810. The results interface 810 may also include an export option 812 to export data (e.g., records) that are returned from a query in the results interface 810. In the embodiment depicted, the export option 812 is operable to export the data into a comma separated value (CSV) format.

In some embodiments, a query of the database explorer 800 may be run against multiple versions of a database backup (e.g., all available versions or a subset of the available versions selected by the user). For example, a SELECT query directed at a particular table may be run on each table of each version of the database (or on a plurality of versions selected by the user). For example, a user may desire to view salary numbers that may have changed across multiple versions of a database. The user may submit a query for the salary numbers and a plurality of results (each corresponding to a version of a table) may be provided to the user.

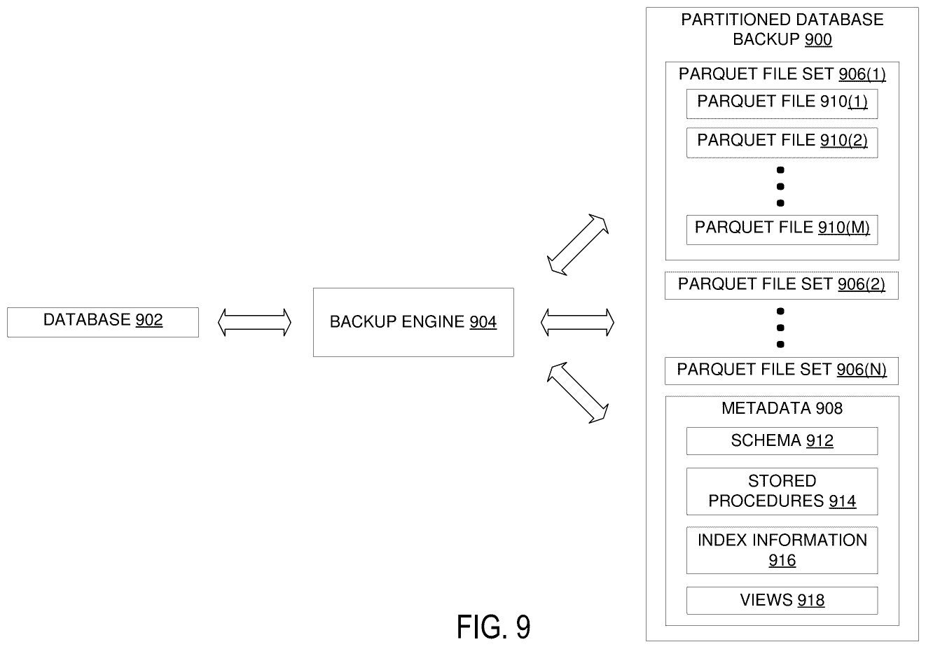

FIG. 9 illustrates a partitioned database backup 900, in accordance with any of the embodiments disclosed herein. A database 902 may be accessed by a backup engine 904, which generates the partitioned database backup 900 based on the contents of the database 902 in a format that allows the backup engine 904 to recover the database 902 (e.g., the format of the recovered database may match the format of the database 902) and to service SQL queries sent to the database backup. In various embodiments, the backup engine 904 may also be operable to perform operations to recover the database 902 from the partitioned database backup 900.

The backup engine 904 may be included, in whole or in part, within the resource backup and search system 108, within a backend 106, at another suitable location within cloud backup environment 100, or at any combination thereof. The backup engine 904 may be implemented by one or more computing devices, such as computing devices 300.

The partitioned database backup 900 includes a plurality of Parquet file sets 906 (e.g., 906(1), 906(2), . . . , 906(N), where N is any suitable integer). Each Parquet file set 906 corresponds to a table of the database 902 and may include any number of Parquet files 910 that collectively store the records of the table. For example, Parquet file set 906(1) includes Parquet files 910(1)-910(M), where M is any suitable integer.

The records of the table corresponding to a Parquet file set 906 may be split among the Parquet files 910 in any suitable manner. In a particular embodiment, a column (e.g., a primary key or a different column) is selected for the table and the records are split among the Parquet files 910 according to the values of the selected column in the various records. The full range of values for the selected column in the records of the table may be determined, the full range may be split up into partial ranges (e.g., that collectively span the full range), each partial range may be assigned to one of the Parquet files 910, and the records of the table may be stored among the Parquet files 910 according to their values for the selected column. For example, a first Parquet file 910(1) may include records having values for the selected column that are within a first range, a second Parquet file 910(2) may include records having values for the selected column that are within a second range, and so on.

As a simplified example, a table with 1,000,000 records that each include a unique value for the selected column may be partitioned, e.g., into 100 Parquet files. If the values for the selected column span from 1 to 1,000,000 in the records (with no repeated value for the selected column), a first Parquet file may include the records that have values for the selected column from 1 to 10,000, a second Parquet file may include the records that have values for the selected column from 10,001 to 20,000, a third Parquet file may include the records that have values for the selected column from 20,001 to 30,000, and so on. In various embodiments, the values of the selected column may or may not be unique and Parquet files for the same table may or may not have the same number of records.

In general, a Parquet file is a columnar storage file format commonly used in the Hadoop ecosystem, though it is supported in a variety of other data processing frameworks (e.g., AWS Athena, Apache Spark, Google BigQuery, etc.). Parquet files store data in columns (using column oriented storage), rather than rows, allowing for more efficient reading of specific columns (without the need to read the entire dataset), resulting in faster query times. Thus, the ordering of the data in a Parquet file may be as follows: C1 R1, C1 R2, C1 R3, . . . C1 RN, C2 R1, C2 R2, C2 R3, . . . C2 RN, C3 R1, C3 R2, C3 R3, . . . C3 RN, CM R1, CM R2, CM R3, . . . , CM RN (where C stands for column, R stands for row, and M and N are any suitable integers). R1 through RN may include all of the rows in the Parquet file or all of the rows of a particular row group (and the Parquet file could include one or more additional row groups. The data may be compressed and/or encrypted in any suitable format.

Metadata 908 may include metadata for the database 902 that may be used in conjunction with the Parquet file set 906 to reconstruct the database 902. Metadata 908 may be stored separately from the Parquet file sets (e.g., in one or more files, objects, or other storage structures that are distinct from the Parquet files 910). In various instances, metadata 908 may be stored in association with the Parquet file sets (e.g., in the same storage device, the same storage device group, the same directory, the same backend 106, etc.).

In the embodiment depicted, metadata 908 includes schema 912, stored procedures 914, index information 916, and views 918. In other embodiments, metadata 908 may include additional information or any subset of this information.

Schema 912 may include any suitable information about the organization of the database 902, such as any information described above with respect to schema information 406. In various embodiments, the schema 912 may include a list of table names of the database 902 as well as the column names and data types for each column of each table. In various embodiments, schema 912 of a database or table may be stored in one or more Parquet files (e.g., that are different from the Parquet files used to store the table records) or other suitable file type.

Stored procedures 914 are collections of one or more SQL statements that are stored and executable on a database server. This allows for modular, reusable code that can be called repeatedly, e.g., to perform complex tasks such as querying, updating, or processing data. Stored procedures 914 may be compiled and/or optimized by a database management system when they are created (potentially enabling faster execution than if the SQL statements were executed individually). In some instances, the stored procedures 914 may include security permissions (e.g., users may be allowed to execute a stored procedure even though the user does not have rights to directly access the underlying tables). In some instances, stored procedures may accept input parameters and/or return output parameters.

Index information 916 may include any suitable information about indexes of the table, such as any of the information described with respect to index information 408.

Views 918 store information describing views of the database. A view in SQL is a virtual table based on the result set of a SQL query. A view functions like a table but doesn't store data itself; rather may dynamically retrieve data from one or more underlying tables when queried. Views are generally used to simplify complex queries (e.g., a view may allow the results of a complex query to be treated as a table), encapsulate logic (e.g., by hiding the complexity of database schema, such as joins or subqueries), enhance security (e.g., views can be used to restrict access to certain rows or columns in a table, users may be given access to a view without receiving direct access to the underlying tables), and provide a layer of abstraction.

The partitioned database backup 900 may be stored in any suitable location. For example, the partitioned database backup 900 may be stored at a backend 106 (e.g., in storage of the backend 106 allocated to the particular organization). In a particular embodiment, the partitioned database backup 900 is stored in an object storage service of a backend 106, such as an Amazon Simple Storage Service (Amazon S3) environment.

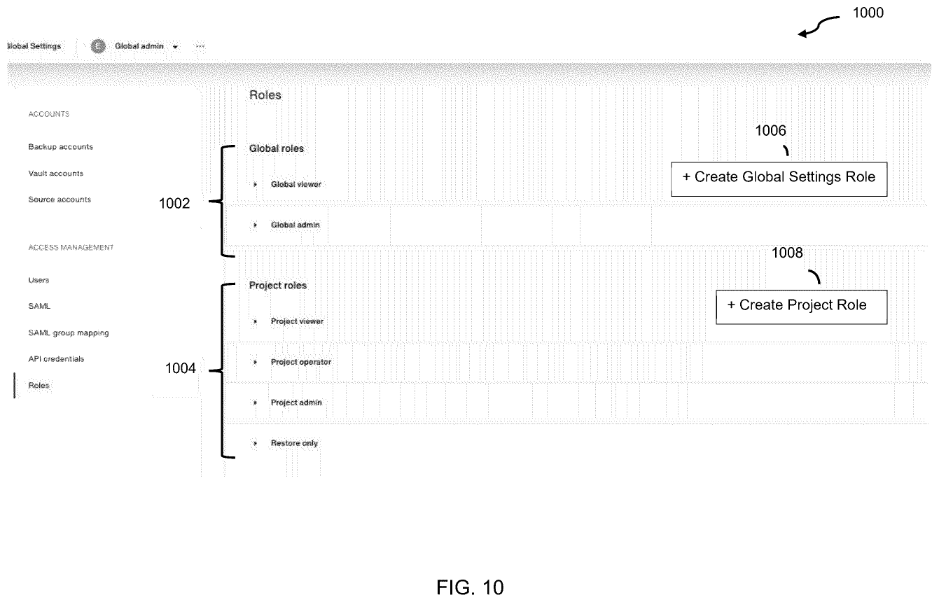

FIG. 10 illustrates an interface 1000 for managing roles with content based access permissions for data backups, in accordance with any of the embodiments disclosed herein. In various embodiments, the interface 1000 may be provided (e.g., by resource backup and search system 108 or other suitable logic) through a web application (e.g., accessed through a web browser executed by a computing device 102), but could also be provided through a native application or by other suitable means.

In the embodiment depicted, the roles include global settings roles and project roles. In this instance, the global settings roles include Account Viewer and Account Admin while the project roles include Project Viewer, Project Operator, Project Admin, and Restore Only.

In various embodiments, the resource backup and search system 108 may implement different projects for an organization with different user accounts, roles, resources, or settings. For example, a particular project may include a first portion of backed up resources for an organization, another project may include a second portion of backed up resources for the organization, and so on. A global settings role may define settings that are global (e.g., apply to all of the projects of the organization), whereas a project role may define settings for a particular project. In addition to content based access permissions that may be applied to all projects, a global settings role may additionally or alternatively define permissions for configuring project roles (e.g., certain users may be able to create and/or edit project roles).

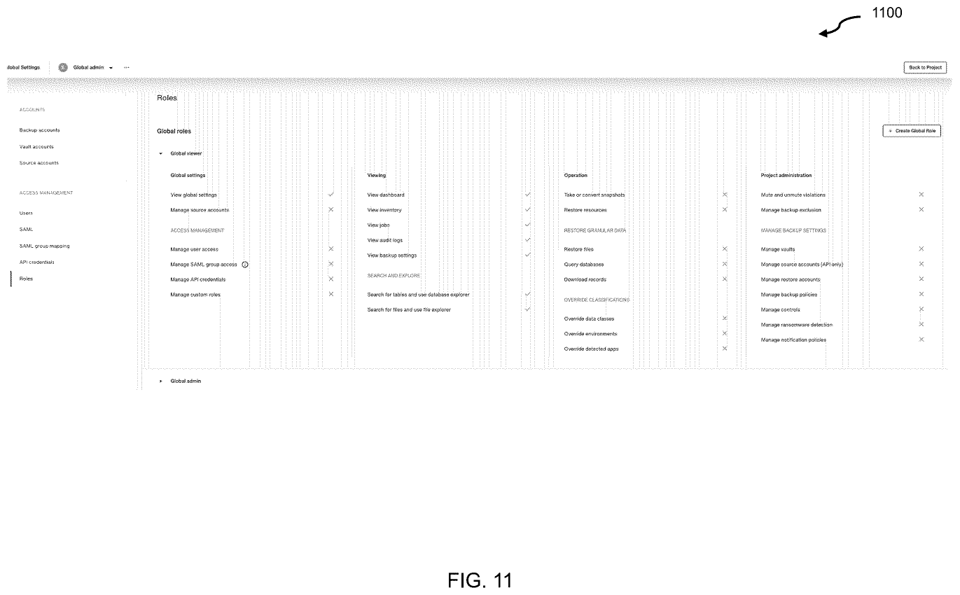

The access permissions of a particular role may be viewed by selecting the role (and the role may be expanded responsive to the selection to show the respective access permissions for the role). The access permissions may define, e.g., which data and/or metadata may be viewed when using an enhanced database search interface 600, database preview interface 700, file explorer (e.g., as shown within interface 1500), database explorer 800, or other search or browsing interface, which sensitive data is viewable but obfuscated, region based access permissions, and restore permissions. Example content based access permissions will be described in more detail in connection with the creation of a role with respect to FIG. 11.

The interface 1000 also includes a link 1006 to create a new global settings role and a link 1008 to create a new project role. Interface 1000 may allow one or more users (e.g., administrators associated with an organization) to create and configures roles which have access to backups of resources dependent on the content of the backed up data or other parameters. Users are created in the system and may be assigned to one or more of the roles. A user is then granted the access rights defined in the role(s) of the user.

Users may be associated with their respective role(s) in any suitable manner. For example, the roles may be stored in a configuration file for the user that includes other settings associated with the account of the user. As another example, a document (e.g., JSON document) or other file or data structure may include an indication of a role and all of the users that have that role. FIG. 11 illustrates an interface 1100 providing a plurality of access permissions for resource backups, in accordance with any of the embodiments disclosed herein. The interface 1100 displays a number of access types and corresponding access permissions that may be defined for a role. The access types and permissions may be displayed responsive to a user request to create a role (e.g., via a link 1006 or 1008) or a request to edit a preexisting role (e.g., by selecting an edit option for a particular role in interface 1100).

In this embodiment, the permissions include viewing permissions, operation permissions, and project administration permissions. In the embodiment depicted, the access types under the viewing permissions section with corresponding permissions include view dashboard, view inventory, view jobs, view audit logs, view backup settings, search for tables, and search for files. The access types with corresponding permissions under the operation permissions section include take snapshots on demand, restore resources, restore files, query databases, download records, override data classes, override environments, and override detected apps. The access types with corresponding permissions under the project administration permissions section include mute and unmute violations, manage backup exclusion, manage vaults, manage restore accounts, manage backup policies, manage controls, and manage notification policies.

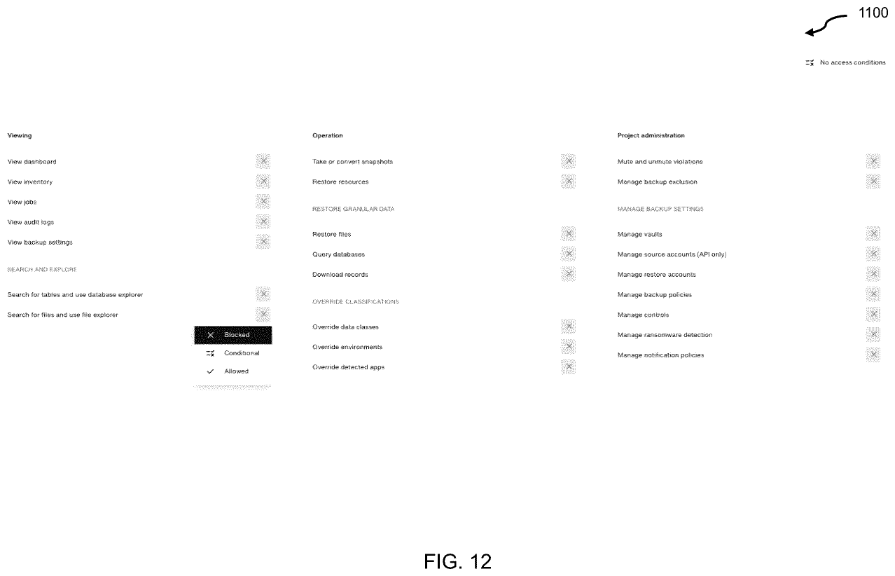

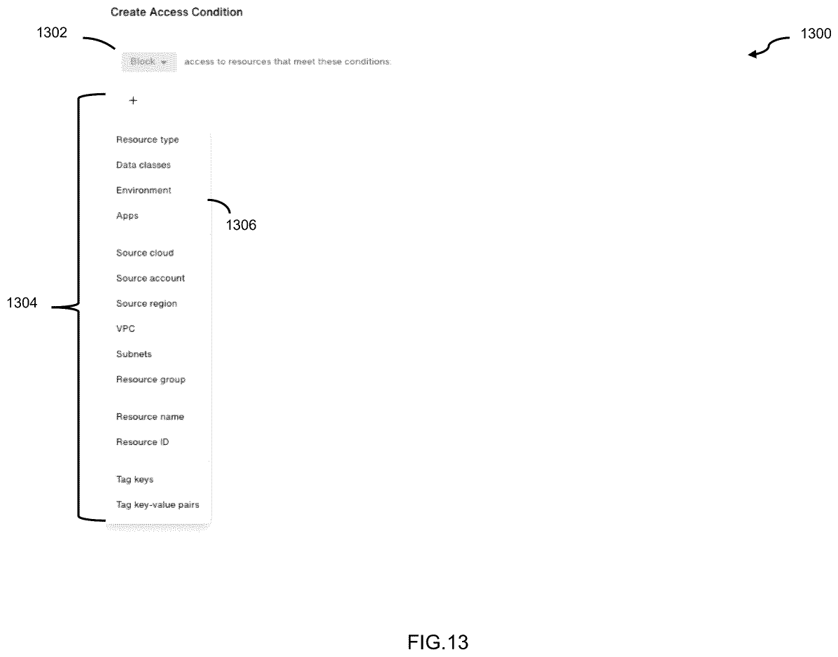

For each of the access types, the corresponding permission may be set to allowed (e.g., unconditionally such that it applies to all resources) or blocked (e.g., unconditionally such that it applies to all resources). In the embodiment of FIG. 11, the role initially has each permission blocked (where an X in line with an access type indicates the corresponding access type is blocked). At least some of the permissions may also be configurable to be set to conditional allowance (e.g., based on the content of the underlying data or other parameters associated with the data). For example, in FIG. 12, when a permission is selected, a popup menu is displayed allowing a user to set the permission as blocked, conditional, or allowed (e.g., responsive to selection of a permission displayed in the interface). Various potential conditional settings will be explored in further detail in connection with FIG. 13.

Returning to the access types and permissions illustrated in FIG. 11, a view dashboard permission may control access to view a dashboard that may be provided to a user (e.g., by resource backup and search system 108 for display on a computing device 102 through a web browser, native application, or other means), where the dashboard comprises various information about the resources available to the user, such as how many resources are available, how many resources are backed up, problems with backups, or other suitable information. The permission may be set to allow viewing of the dashboard without restrictions, to not allow viewing of the dashboard at all, or to conditionally allow viewing of the dashboard (e.g., based on one or more content based restrictions as described below). For example, the information provided via the dashboard may be filtered according to the access permissions defined by one or more access conditions. As an example, a user having a certain role should only view information associated with virtual machines, and thus information about other resources such as databases or buckets may be blocked (e.g., filtered) from the dashboard based on the conditional access permission defined for the view dashboard access type.

The view inventory permission may control access to an inventory (e.g., inventory 1600) that may be provided to a user (e.g., by resource backup and search system 108 for display on a computing device 102). The inventory may show the resources (e.g., VMs, buckets, or databases) visible to the user to allow the user to browse information about the available resources. The permission may be set to allow viewing of the inventory without restriction, to not allow viewing of the inventory at all, or to conditionally allow viewing of the inventory (e.g., based on one or more content based restrictions as described below). For example, the information provided via the inventory may be filtered according to the access permissions defined by the conditional. As an example, the user configuring the role may desire to only allow the role to view databases (and thus other resources such as VMs or buckets) may be blocked (e.g., filtered) from the inventory.

In various embodiments, the databases for which information is displayed (whether in an inventory, a dashboard, an explorer, other interface, etc.) may include databases with source locations in a managed database service (e.g., Amazon's RDS or the like) as well as databases that are within VMs that are backed up by a backend 106 (thus, when backing up a VM, the resource backup and search system 108 may scan the VM for databases present within the VM and may extract any necessary information about such databases to enable display of any of the information described herein with respect to databases responsive to searching or browsing by a user).

The view jobs permission may control access to view jobs in progress, where a job may be a backup or restore process for one or more resources. The permission may be set to allow viewing of the jobs without restrictions, to not allow viewing of the jobs at all, or to conditionally allow viewing of the jobs (e.g., based on one or more content based restrictions as described below).

The view audit logs permission may control access to view an audit log, where the audit log may comprise a list of transactions performed with respect to the resources (e.g., backups created, restores performed, jobs created, configuration created, or the like). The permission may be set to allow viewing of the logs without restrictions, to not allow viewing of the logs at all, or to conditionally allow viewing of the logs (e.g., based on one or more content based restrictions as described below). For example, transactions of the logs may be filtered out based on the conditional access specified for the role.

The view backup settings permission controls access to backup settings. The backup settings may specify which resources are to be backed up and how the resources are to be backed up (e.g., how often and where the resources will be backed up). The permission may be set to allow viewing of the backup settings without restrictions, to not allow viewing of the backup settings at all, or to conditionally allow viewing of the backup settings (e.g., based on one or more content based restrictions as described below).

The search for tables permission controls access to a search interface, such as the enhanced database search interface 600 (and database preview interface 700 in some embodiments). In other embodiments, separate permissions (e.g., a permission for the enhanced database search interface 600 and another permission for the database preview interface 700) may be present and configurable. The permission may be set to allow searching for tables (and previewing databases) without any restrictions, to not allow searching for tables (and previewing databases), or to conditionally allow searching for tables and previewing databases (e.g., based on one or more content based restrictions as described below).

With respect to searching, a particular category of content may be excluded from a search based on the permission. In such an instance, such content may be ignored when determining whether a table matches the search expression. For example, if PII is excluded from a search, then any columns that include PII may be ignored when determining whether a table matches the search expression.

With respect to display of search results within the search interface (e.g., 600), in one embodiment, data that is within a category of content that is excluded per the access conditions may be hidden when the table or a portion thereof is presented to the user responsive to a search. For example, if PII is excluded, the field names of the table that include PII may be omitted and the other field names of the tables may be displayed. In another embodiment, if a table that would otherwise match a search includes any data that is excluded per the access conditions, the entire table could be omitted from the results displayed.

With respect to the display of data within a table (e.g., in the database preview interface 700), in one embodiment, data that is within a category of content that is excluded may be hidden, while other data of the same table may be displayed. For example, if PII is excluded, any columns that include PII in a table may be entirely omitted while the other columns are displayed. As an alternative, instead of hiding the entire column, the data of the column may be obfuscated while the title of the column is displayed.

The search for files permission controls access to a file search interface (e.g., 1500, which may be the same interface as the enhanced database search interface 600 but with “files” selected for the search rather than “tables”). In various embodiments, in addition to backing up databases, the resource backup and search system 108 may backup any suitable files of a computing system (e.g., system files, executable files, data files, media files, document files, or the like). The permission may be set to allow searching for files without any restrictions, to not allow searching for files, or to conditionally allow searching for files (e.g., based on content of the files or other parameters).

With respect to searching, a particular category of content may be excluded from a search. In such an instance, such content may be ignored when determining whether a file matches the search expression. For example, if PII is excluded from a search, then any files that include PII may be ignored when determining whether a file matches the search expression.

With respect to display of results of a file search, in one embodiment, data that is within a category of content that is excluded may be hidden or obfuscated, while other data of the same file may be displayed or otherwise included in the results that are returned. For example, if PII is excluded, then PII of a preview of the file that is displayed may be obscured or the PII may be removed from a file that is made available to the user responsive to the search.

Thus, in some instances, a file that includes content blocked per the permission may be completely hidden from a user (e.g., not returned responsive to a search that would otherwise the file) or partially hidden from a user (e.g., metadata about the file may be provided responsive to the search or metadata and a portion of the contents of the file may be provided).

The take snapshots on demand permission controls whether a copy of a backup of a resource may be made. The permission may be set to allow snapshots on demand for all resources, to not allow snapshots on demand at all, or to conditionally allow snapshots for some of the resources. For example, the role may be allowed to take snapshots of VMs, but not databases. As another example, the role may be allowed to take snapshots of resources that do not include sensitive information but not allowed to take snapshots of resources that include sensitive information.

The restore resources permission controls whether resources may be restored by a user having the role. Restoration of a resource may include using a backed up copy of the resource to restore the resource at the source of the resource. The permission may be set to allow the role to restore any of the resources, to not allow the role to restore of any of the resources, or to conditionally allow the role to restore some of the resources.

The restore files permission controls whether files may be restored by a user having the role. Restoration of a file may include using a backed up copy of the file to restore the file at the source of the resource. The permission may be set to allow the role to restore any of the files, to not allow the role to restore of any of the files, or to conditionally allow the role to restore some of the files.

The query databases permission controls whether a database may be queried by the role (e.g., as described in connection with database explorer 800). The permission may be set to allow the role to query any of the databases, to not allow the role to query any of the databases, or to conditionally allow the role to query some of the databases or perform partial queries of databases (e.g., where excluded data is omitted from the results or obscured within the results).

With respect to querying a table in the database explorer 800, data that is within a category of content that is excluded may be excluded from the query. For example, the query may operate on the table as if the table did not include such data and the results will thus not include any of the excluded data. In another example, the query may return the excluded data in an obscured format. In yet another example, the excluded data and associated metadata (e.g., a field header) may be omitted from the query results.

The download records permission controls whether records of databases may be downloaded by a user having the role. The permission may be set to allow the role to download any of the records from any of the databases, to block downloading of any records from any of the databases, or to conditionally allow the user having the role to download only a portion of the records of the databases.

FIG. 13 illustrates an interface 1300 for configuring a content based access permission for databackups, in accordance with any of the embodiments disclosed herein. In this interface, content that is allowed and/or excluded may be defined. For example, by default (or through user selection) all content may be allowed and one or more explicit exclusions for categories of content may be defined in the interface. As another example, by default (or through user selection) all content may be excluded and one or more explicit inclusions for categories of content may be defined in the interface. The access conditions described herein may be applied to any of the permissions above or other suitable data access permissions for the resources.

Access to the backed up data may be based on any suitable categories of content, which may be defined as inclusions or exclusions. In various embodiments, such categories may include one or more of sensitive data, a type of runtime environment, a type of resource, resources running a particular type of application, geographic region of the data, or the manner of hosting by the cloud infrastructure.

FIG. 13 illustrates an interface 1300 for configuring a content based access permission for a cloud backup, in accordance with any of the embodiments disclosed herein. This interface 1300 is an example of an interface that may be provided to the user when the user has selected conditional access for a particular permission (e.g., as shown in FIG. 12).

The interface 1300 includes a selector 1302 to specify whether the condition(s) entered in the conditions interface 1304 are applied to block access to resources (in which case the resources that do not meet the condition(s) may be allowed) or to allow access to resources (in which case the resources that do not meet the condition(s) may be blocked).

A popup window 1306 allows selection of a particular content property. In the embodiment depicted, the available content properties include resource type, cloud provider, data classes, environment, apps, account, source region, virtual private cloud (VPC), subnets, resource group, and name. Other suitable content properties are contemplated herein.

The resource type property allows selection of the type and/or subtype of a resource. In general, a resource represents a grouping of data (which may or may not be backed up in the cloud), such as a virtual machine, a database, and a bucket. In one embodiment, the resource type property may allow selection of one or more of a virtual machine, a database, or a bucket and access to these types of resources are conditioned on the selection. In some embodiments, the resource type property may also allow selection of a subtype of a resource, such as an application associated with (e.g., used to create or open) the resource. For example, for a database, the subtype could include any one or more of Hadoop, MySQL, MongoDB, PostgresSQL, Redis, etc.

The cloud provider property specifies the provider that hosts a backup copy of the resource. For example, this may specify a provider of a backend, such as Amazon Web Services, Microsoft Azure, Google Cloud Platform, or the like.

The data class property may specify a class of the data. Examples of data classes may include, e.g., sensitive data and non-sensitive data. Additional examples of data classes may include different types of sensitive data, such as personally identifiable information (PII), protected health information (PHI), or financial information (FI).

The environment property may specify a runtime environment of the resource (e.g., the runtime environment in which the resource is run). Examples of environments include a production environment (e.g., an internal production environment), a testing environment, and development environments.

The apps property may specify a particular type of application that is run by the resource. An option within the apps property may specify a single application (e.g., Hadoop, Microsoft Exchange Server, Microsoft Active Directory Domain Controller, Microsoft SQL Server, MongoDB, MySQL, Oracle Database Server, PostgreSQL, Redis, SAP Application Server, or the like) or an application type that may apply to multiple applications (e.g., database applications, message queues, web applications, or the like).

The source region property may specify one or more geographic regions of source data (e.g., the location of one or more computing systems that store data that is backed up at a different location such as a backend 106).

As an example, a conditional may grant view access, backup access, or restore access only to data originating from one or more specific source regions. As another example, a conditional may limit view access, backup access, or restore access for sensitive data, such that access to such data is confined to sensitive data originating from one or more specific source regions.

Other properties (e.g., account property, VPC property, subnets property, and resource group property) may specify one or more parameters associated with how the data is hosted by the cloud infrastructure (e.g., one or more of backends 106). The account property may specify an account identifier of a cloud account hosting the resource, the VPC property may specify an identifier of a VPC (e.g., a logically isolated section of a cloud provider's infrastructure where cloud resources may be launched and managed in a secure and private environment). The subnets property may specify a subnet of a cloud infrastructure (e.g., one or more backends 106), where a subnet is a segmented portion of the cloud infrastructure (e.g., a portion of a VPC) defined by a range of IP addresses (e.g., through a classless inter-domain routing (CIDR) block or other means of identification). The resource group property may specify a logical container allowing for management of resources as a single entity. A resource group may be identified by any suitable identifier.

The name property may specify a string that may be compared against a name, tag, or field of a resource to determine if the resource matches or does not match the name. Any suitable comparison operator may be used within the name property, such as contains, does not contain, starts with, ends with, not start with, not end with, one of, not one of, other search operators described above, or other suitable comparison operator.

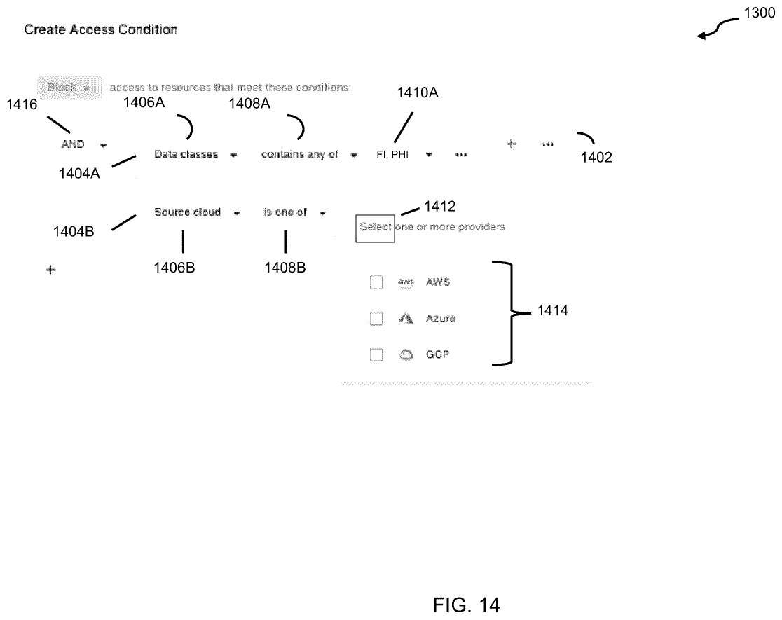

FIG. 14 illustrates another view of the interface 1300 for configuring content based access permissions for database backups, in accordance with any of the embodiments disclosed herein. In this embodiment, for a particular permission (e.g., as shown in FIG. 11), the conditions are blocking access to any resources that contain any of FI or PHI and that are hosted by a cloud provider (to be selected, e.g., from Amazon Web Services (AWS), Microsoft Azure, or Google Clout Platform (GCP).

The interface 1300 may allow a user to add any number of condition sets 1402 that may each include at least one permission set 1402. A permission set 1404 may include a permission type 1406, a permission qualifier 1408, and one or more permission parameters 1410 corresponding to the respective permission type 1406 and permission qualifier 1408. For at least some of the permission types 1406 (e.g., those compatible with selection of discrete parameter values), responsive to selection of a permission type 1406 and activation of a parameter selector 1412, the interface 1300 may display a parameter list 1414 that includes the allowable values for the permission type (e.g., 1406B).

The permission qualifier 1408 specifies the relationship between the permission type 1406 and the corresponding parameter values 1410. In various embodiments, any suitable qualifier may be used, such as contains any of, does not contain any of, starts with, ends with, does not start with, does not end with, one of, not one of, or other suitable qualifier that may link the permission type 1406 to the corresponding one or more permission parameters 1410. In the embodiment depicted, permission type 1406A is set to data classes, the permission qualifier 1408 is set to contains any of, and the permission parameters 1410 are set to FI and PHI. Permission type 1406B is set to cloud provider, permission qualifier 1408B is set to is one of, and no corresponding parameter values have been set yet.

When a condition set 1402 includes multiple permission sets 1404, the permission sets 1404 may be linked via an operator 1416 (e.g., a Boolean operator such as AND or OR). Although not shown, when the condition includes multiple condition sets 1402, the condition sets 1402 may be linked via an operator (e.g., a Boolean operator such as AND or OR).

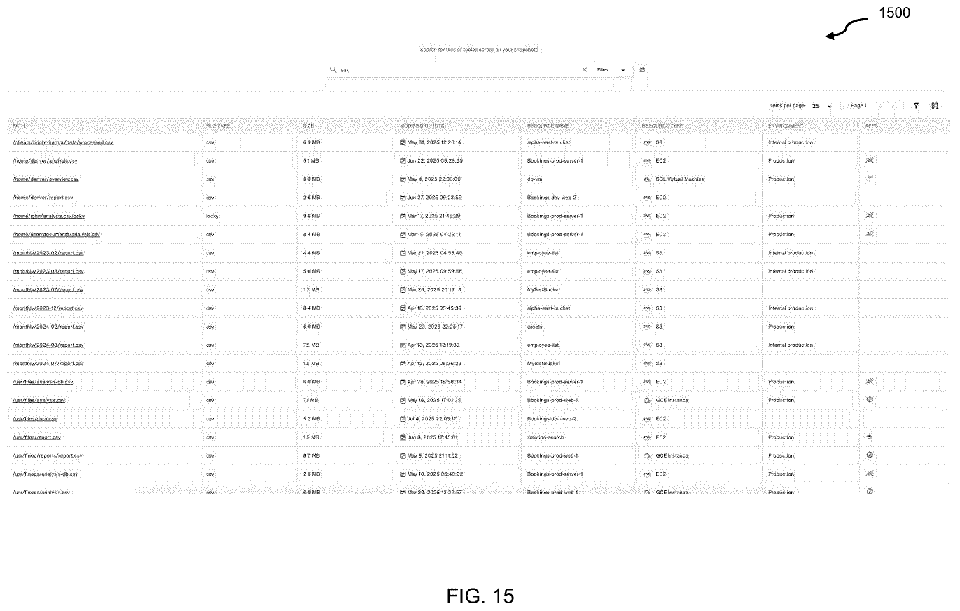

Collectively, the one or more condition sets 1402 and their respective one or more permission sets 1404 define the access conditions for the corresponding permission (e.g., one of the permissions of interface 1100 for which a condition is being set via the interface 1300). FIG. 15 illustrates an interface 1500 with search results of backed up files, in accordance with any of the embodiments disclosed herein. Consistent with the disclosure herein, such an interface 1500 may omit results for which the user does not have permission to view. For example, when a user searches for backed up files, the results provided may be filtered based on the role. For example, if a filename contains sensitive information, the file will not be presented or the sensitive part in the name may be obfuscated depending on the configuration. If the file includes sensitive information but the filename does not, the name may be presented, but the user may not be able to explore the file content (unless granted such permissions under the access conditions of the user's role).

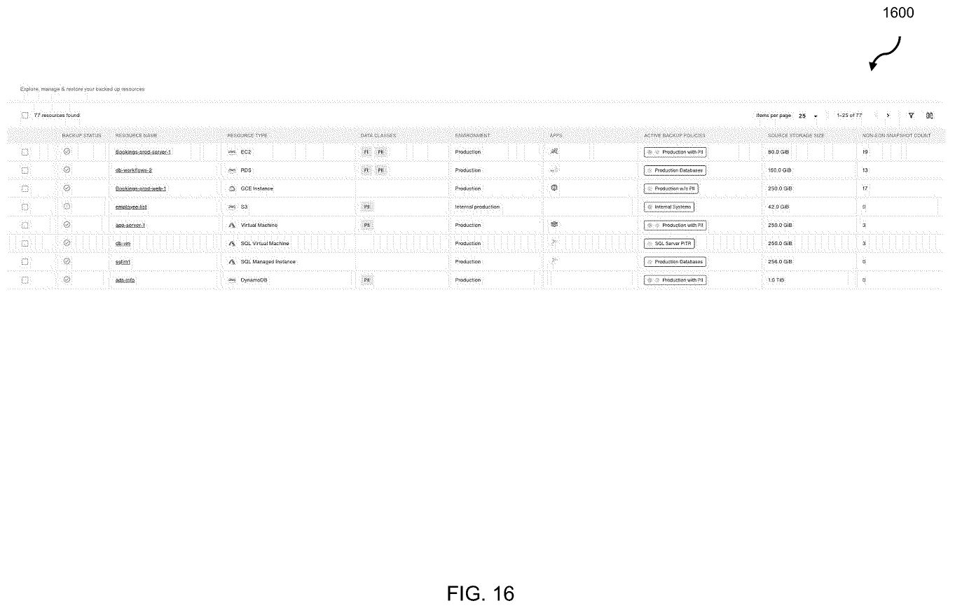

FIG. 16 illustrates an inventory 1600 of resource backups, in accordance with any of the embodiments disclosed herein. In the embodiment depicted, the inventory 1600 includes a list of available snapshots (e.g., from which time there is a copy of the resource). In various embodiments, users associated with a role that does not have the appropriate permissions may not be able to see some of the copies (e.g., if the copies have sensitive information) and may not be able to restore such copies.

The provision of various access types and conditional access conditions for the corresponding permissions may enable a variety of use cases, some of which are now described.

In one example, permissions set for a role may define which data a user (e.g., a backup administrator) may explore when utilizing a file or database explorer. For example, if the access conditions allow, the user may be able to view filenames of files that include sensitive information. As another example, if the access conditions allow, the user may be able to view content of files that contain sensitive information. As yet another example, if the access conditions allow, the user may view tables which include sensitive information.

In another example, the permissions set for a role may define whether data is obfuscated when a table or file includes sensitive data. For example, one role may be able to see sensitive data while another role may only see sensitive data in an obfuscated format.

In another example, the permissions set for a role may define region based access. For example, a particular role may only be able to view, backup, and restore data (e.g., within tables or files) that originates from one or more specific geographic regions. As another example, a particular role may only be able to view, backup, and restore data that includes sensitive information if the data originates from one or more specific geographic regions.

In another example, the permissions set for a role may define restore rights. For example, a particular role may be granted permission to only restore single elements (such as a file or a row of a table) of a resource that includes sensitive data. As another example, a role may restore full copies of resources which contain sensitive data (and in some instances could be blocked from later accessing the restored data). As another example, a role may be limited to restoring only copies of resources that do not include sensitive data. As another example, a role may be limited as to the source locations of resources with sensitive information that may be restored.

In another example, a database may include personal information that is to be protected. A generic database administrator may be assigned to a role that can only restore databases that do not include personal information, while a user with a different role may be able to restore databases with personal information.

In another example, when a user with a particular role searches for tables, the user may only view tables that do not include sensitive information. As another example, when a user with another role searches for tables, the user may view tables (or previews thereof) with sensitive information but the sensitive information may be obfuscated or omitted from the information presented, depending on the configuration. Similarly, when querying data of the tables (e.g., via database explorer 800), users of roles without adequate permission may not see some of the columns or may see columns with obfuscated values.

In various examples, different content based permissions may be granted for different operations for the same role. For example, the role may be able to search for tables with PII, but not view contents of the table, query the tables, or restore the tables.

In one example, a role may have a setting such that if a file includes PII, the file may not be viewable or restored.

In various embodiments, when the resource backup and search system 108 is connected to a user account, it may scan all the resources associated with that user account. The content of the resources may be inspected for parameters before backup policies are applied (e.g., where such backup policies may trigger backups using the same permission types) and the resources are backed up. In subsequent backups, the content of the resources is again scanned to determine parameters (e.g., parameters that may be compared against permission parameters for the various permission types). Upon performance of a backup, the parameters (if applicable) may be stored for each resource (e.g., a file which includes HIPPA information may be marked as sensitive when backing up a VM containing the file).

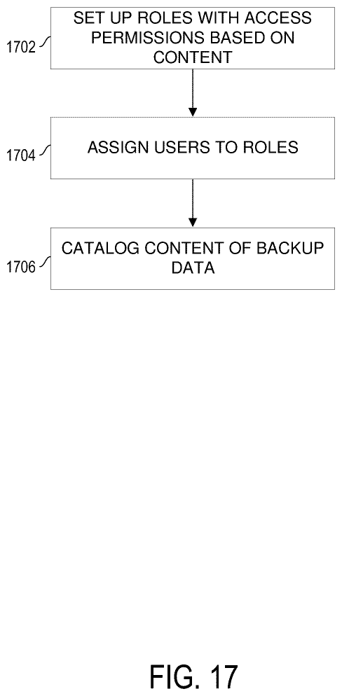

FIG. 17 illustrates a flow for setting up a system to implement roles with content based access permissions, in accordance with any of the embodiments disclosed herein.

At 1702, roles with access permissions based on content are set up. In various embodiments, a user associated with an organization may utilize an interface (e.g., provided via a web browser, native application, or other interface) executed on a computing device 102 to communicate configuration information for the roles to the resource backup and search system 108. The resource backup and search system 108 may store the permissions defined by the role as a data structure, such as a JavaScript Object Notation (JSON) document. The JSON document may comprise a plurality of keys, where a key includes the name of one of the various access types that may be specified by user requests, such as view dashboard, view inventory, view jobs, view audit logs, view backup settings, search for tables, search for files, take snapshots on demand, restore resources, restore files, query databases, download records, override data classes, override environments, override detected apps, mute and unmute violations, manage backup exclusion, manage vaults, manage restore accounts, manage backup policies, manage controls, or manage notification policies. The JSON document may also comprise values corresponding to the keys. In some embodiments, for a particular key, the value may be constrained to one of “allowed”, “not allowed”, or a data structure defining conditions for access (e.g., as illustrated in connection with FIGS. 13-14). In a particular embodiment, the conditions for access may be defined in another JSON document. Thus, any number of the keys for the access types may have values that are themselves JSON documents.

At 1704, users of the organization are assigned to the roles (e.g., by an administrator or other user associated with the organization). A particular user may be assigned to one or more roles.

At 1706, content of backed up data is catalogued. This cataloguing may include storing, for the various resources, metadata comprising indications of the type of content included in the resources. These indications may be stored on a resource by resource basis (and could also include separate collections of metadata for separate versions of the backed up resource). For a particular resource, this metadata is stored in association with the backup of the resource.

As an example, a backup of a table may be stored in association with a JSON document including properties of the table (e.g., which type of database, the source region of the database, the schema of the table (e.g., the fields of the table and what type of content is included within the field, e.g., whether the field has sensitive information or the type of sensitive information in the field).

As another example, a backup of a VM may be stored in association with a JSON document which describes the VM properties, such as which applications are running in the VM and whether the VM (in the aggregate) contains files which include sensitive information (e.g., PII, FII), and whether ransomware is suspected on the VM. In various embodiments, this metadata may be stored for each version of the backup. Similar metadata (e.g., including whether and what type of sensitive content are stored by the file) may also be stored for each individual file of the VM.

In various embodiments, the cataloguing may occur incrementally (e.g., the metadata for a particular resource may be created or updated at the time the resource is backed up). In some instances, the cataloguing may be aggregated (e.g., a plurality of resources may be scanned and the metadata may be generated or edited for each of the resources).

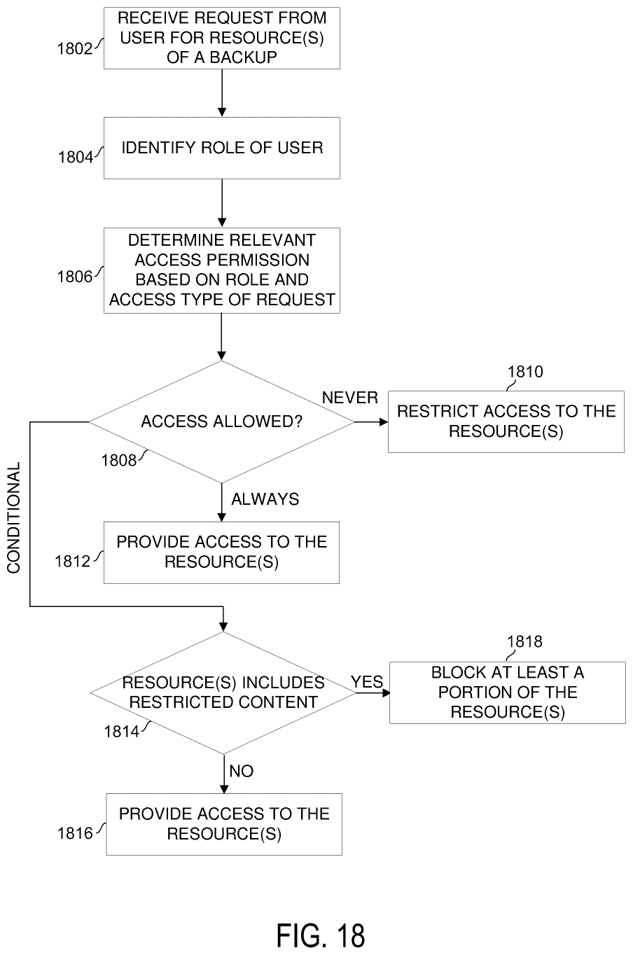

FIG. 18 illustrates a flow for servicing requests for resources using roles with content based access permissions, in accordance with any of the embodiments disclosed herein.

At 1802, a request is received from a user. For example, the user may utilize a computing device 102 to send a request to the resource backup and search system 108. The request may specify an access type for at least one resource that is backed up (e.g., in a backend 106 accessible through resource backup and search system 108). In some instances, the request may also include or otherwise be associated with (e.g., may be sent during a session through which the user has been authenticated through) information identifying the user (e.g., the name of the user, a login name for the user, or other identifying information).

At 1804, a role of the user is identified based on the information identifying the user. For example, a data structure that lists users and their corresponding roles may be searched to determine the role of the user. If the user is associated with multiple roles, these roles may be identified.

At 1806, an access permission is determined based on the role of the user and the access type of the request. If the user is associated with multiple roles, the access permission of the role that grants the most permissive access may be selected. In some instances, the access permission may be determined by accessing a JSON document or other data structure corresponding to the role, searching the keys of the JSON document for the access type of the request, and ascertaining the value corresponding to the access type.

At 1808, a determination of whether access to the one or more resources is allowed is made. If the access type is never allowed according to the role, then at 1810 access to the at least one resource is restricted. If the access type is always allowed according to the role, then at 1812 access to the at least one resource is provided.

If the access type is allowed conditionally, a determination of whether the requested resource(s) include content that is restricted by the role. In some instances, such a determination may be made on a resource by resource basis (e.g., by accessing a JSON document or other data structure comprising metadata corresponding to the resource or multiple such JSON documents or data structures that each correspond to a different version for multiple backed up versions of the resource). If a resource does not include content that is restricted according to the role, then access is provided to the resource at 1816. If a resource includes content that is restricted according to the role, then the resource may either be entirely blocked or the content that is restricted may be blocked or obfuscated while the remainder of the resource is provided responsive to the request.

As one example, when a user requests to view a table, but the role of the user does not grant permission to view PII, the relevant data of the table may be read from the backup of the table (e.g., a collection of Parquet files) and stored in any suitable data structure. For example, the table (or a portion thereof) may be stored in data structure having a Parquet format, a comma separated value (CSV) format, HTML (e.g., for display by the computing device 102), direct insertion into a target database format (e.g., the format of the source database prior to the database being backed up). When the data is moved into the data structure, the restricted data content (e.g., columns including PII or column names of columns including PII) may be omitted from the data structure or obfuscated.

As another example, when a user requests to access specific resources (e.g., view snapshots), the metadata for each snapshot may be read and the user will only be able to view snapshots which do not include content that is not allowed to be viewed according to the role.

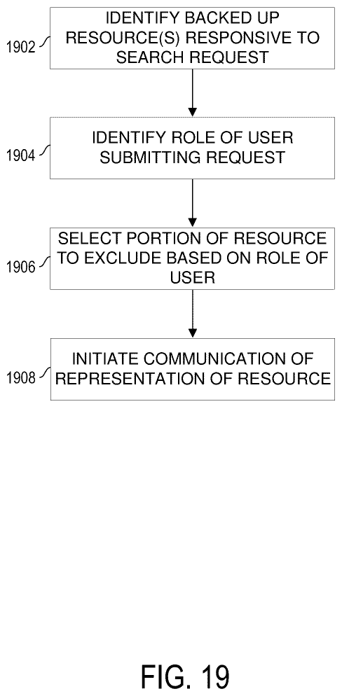

FIG. 19 illustrates a flow for excluding portions of resources based on roles with content based access permissions, in accordance with any of the embodiments disclosed herein.

At 1902, at least one backed up resource is identified responsive to a search request. For example, resource matching a search expression may be identified in any suitable manner, such as is described above or in other suitable manner.

At 1904, a role of the user that submitted the request is identified. At 1906, a portion of the resource to exclude is selected based on the role of the user. For example, the role may define one or more particular types of content that are not accessible to users having that role. In some instances, the one or more particular types of content that are not accessible may be defined per access type for a plurality of access types. The portion of the resource that is excluded may be selected based on an examination of metadata describing at least one type of data included in the resource. The metadata may indicate that the resource includes at least one data type that is not allowed to be accessed by users that include the particular role.

At 1908, communication of a representation of the resource is initiated. The representation of the resource may omit or obfuscate the portion of the resource that is excluded based on the role of the user. The remainder of the resource may be communicated (in any suitable format) to the user requesting the resource.

It is important to note that the operations illustrated in the flows herein represent only some of the possible scenarios that may be executed by, or within, the various components of the systems described herein. Some of these operations may be removed or repeated where appropriate, or these steps may be modified or changed considerably without departing from the scope of the present disclosure. In addition, the timing of these operations may be altered considerably. The preceding operational flows have been offered for purposes of example and discussion.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. For example, the phrases “A and/or B” and “A or B” may mean (A), (B), or (A and B), while the phrase “A, B, and/or C” means (A), (B), (C), (A and B), (A and C), (B and C), or (A, B, and C) unless the context indicates otherwise.

As used throughout this description, and in the claims, a list of items joined by the term “at least one of” or “one or more of” can mean any combination of the listed terms.

What is claimed is:

1. A method comprising:
responsive to a search request from a computing system of a user of an organization, identifying a resource that is backed up in a cloud backup environment;
identifying a role of the user from a plurality of roles established for the organization, wherein the role is assignable to a plurality of users of the organization;
selecting a portion of the resource to exclude from a representation of the resource, wherein the selection of the portion is based on the role of the user; and
initiating communication of the representation of the resource to the computing system of the user.

2. The method of claim 1, wherein the portion that is selected for exclusion from the representation is obscured within the representation of the resource.

3. The method of claim 1, wherein the portion that is selected for exclusion from the representation is omitted from the representation of the resource.

4. The method of claim 1, wherein the portion that is selected for exclusion from the representation includes values of a column of a database.

5. The method of claim 4, wherein a title of the column of the database is included in the representation of the resource.

6. The method of claim 1, wherein the portion that is selected for exclusion from the representation include personally identifiable information.

7. An apparatus comprising:
a communication interface to receive a search request from a computing system of a user of an organization; and
at least one processor to:
responsive to the search request, identify a resource that is backed up in a cloud backup environment;
identify a role of the user from a plurality of roles established for the organization, wherein the role is assignable to a plurality of users of the organization;
select a portion of the resource to exclude from a representation of the resource, wherein the selection of the portion is based on the role of the user; and
initiate communication of the representation of the resource to the computing system of the user.

8. The apparatus of claim 7, wherein the portion that is selected for exclusion from the representation is obscured within the representation of the resource.

9. The apparatus of claim 7, wherein the portion that is selected for exclusion from the representation is omitted from the representation of the resource.

10. The apparatus of claim 7, wherein the portion that is selected for exclusion from the representation includes values of a column of a database.

11. The apparatus of claim 10, wherein a title of the column of the database is included in the representation of the resource.

12. The apparatus of claim 7, wherein the portion that is selected for exclusion from the representation include personally identifiable information.

13. At least one computer-readable non-transitory media comprising one or more instructions that when executed by at least one processor configure the at least one processor to cause performance of operations comprising:
responsive to a search request from a computing system of a user of an organization, identifying a resource that is backed up in a cloud backup environment;
identifying a role of the user from a plurality of roles established for the organization, wherein the role is assignable to a plurality of users of the organization;
selecting a portion of the resource to exclude from a representation of the resource, wherein the selection of the portion is based on the role of the user; and
initiating communication of the representation of the resource to the computing system of the user.

14. The at least one media of claim 13, wherein the portion that is selected for exclusion from the representation is obscured within the representation of the resource.

15. The at least one media of claim 13, wherein the portion that is selected for exclusion from the representation is omitted from the representation of the resource.

16. The at least one media of claim 13, wherein the portion that is selected for exclusion from the representation includes values of a column of a database.

17. The at least one media of claim 13, wherein a title of the column of the database is included in the representation of the resource.

18. The at least one media of claim 13, wherein the portion that is selected for exclusion from the representation include personally identifiable information.
